(19) United States
(12) Patent Application Publication
(10) Pub. No.: US 2019/0271775 A1
(43) Pub. Date: Sep. 5, 2019

(54) MOTION DETECTION USING THE MAGNITUDE OF CHANNEL IMPULSE RESPONSE

(71) Applicant: QUALCOMM Incorporated, San Diego, CA (US)

(72) Inventors: Xiaoxin Zhang, Sunnyvale, CA (US); Youngsin Lee, Seoul (KR); Ning Zhang, Saratoga, CA (US); Erik Lindskog, Cupertino, CA (US); Vincent Knowles Jones, IV, Redwood City, CA (US)

(21) Appl. No.: 15/983,065

(22) Filed: May 17, 2018

Related U.S. Application Data
(63) Continuation-in-part of application No. 15/909,830, filed on Mar. 1, 2018.

(51) Int. Cl. G01S 13/56; H04W 64/00; H04W 52/02; H04W 4/38; G01S 13/00

(52) U.S. Cl. CPC G01S 13/56; H04W 64/006; G01S 13/003; H04W 4/38; H04W 52/0225

(57) ABSTRACT

This disclosure provides systems, methods and apparatuses for detecting motion based on one or more wireless signals. In some implementations, a receiving device may receive a first frame and a second frame from a transmitting device, may determine a first channel impulse response (CIR) based on the first frame, may determine a second CIR based on the second frame, may determine a difference between a shape of the first CIR and a shape of the second CIR, and may detect motion based on the determined difference.

### CROSS-REFERENCE TO RELATED APPLICATIONS

This patent application is a continuation-in-part of and claims priority under 35 U.S.C. 120 to commonly owned U.S. patent application Ser. No. 15/909,830 entitled “METHOD AND APPARATUS FOR MOTION REGULATORY DOMAIN SECURITY TECHNIQUES FOR WIRELESS DEVICES” filed on Mar. 1, 2018, the entirety of which is incorporated by reference herein.

### TECHNICAL FIELD

This disclosure relates generally to wireless networks, and specifically to detecting the presence or motion of an object.

### DESCRIPTION OF THE RELATED TECHNOLOGY

A wireless local area network (WLAN) may be formed by one or more access points (APs) that provide a shared wireless medium for use by a number of client devices. Each AP, which may correspond to a Basic Service Set (BSS), periodically broadcasts beacon frames to enable compatible client devices within wireless range of the AP to establish and/or maintain a communication link with the WLAN. WLANs that operate in accordance with the IEEE 802.11 family of standards are commonly referred to as Wi-Fi networks.

The Internet of Things (IoT), which may refer to a communication system in which a wide variety of objects and devices wirelessly communicate with each other, is becoming increasingly popular in fields as diverse as environmental monitoring, building and home automation, energy management, medical and healthcare systems, and entertainment systems. IoT devices, which may include objects such as sensors, home appliances, smart televisions, light switches, thermostats, and smart meters, typically communicate with other wireless devices using communication protocols such as Bluetooth and Wi-Fi.

In at least one application of IoT, detecting an object or motion of an object in an environment where Wi-Fi network exits is highly desirable. The information resulting from detecting the motion of an object has many useful applications. For example, detecting motion of an object assists in identifying an unauthorized entry in a space. Therefore, it is important to detect the motion of an object in a reliable and accurate manner.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for motion detection. The method can include receiving a first frame and a second frame from a transmitting device, determining a first channel impulse response (CIR) based on the first frame, determining a second CIR based on the second frame, determining a difference between a shape of the first CIR and a shape of the second CIR, and detecting motion based on the determined difference. In some implementations, the method can also include indicating a presence of motion based on the difference exceeding a value, and indicating an absence of motion based on the difference not exceeding the value. In some aspects, the first frame and the second frame can be received in the same wireless signal. In other aspects, the first frame can be received in a first wireless signal, and the second frame can be received in a second wireless signal distinct from the first wireless signal.

In some implementations, the first CIR can be a CIR magnitude profile of the first frame, and the second CIR can be a CIR magnitude profile of the second frame. The method can determine the difference by determining a plurality of cross-correlation levels between the CIR magnitude profile of the first frame and the CIR magnitude profile of the second frame, identifying a peak cross-correlation level from the plurality of determined cross-correlation levels, and comparing the identified peak cross-correlation level with a correlation degree threshold. In some aspects, the method can also include indicating a presence of motion based on the identified peak cross-correlation level not exceeding the correlation degree threshold, and indicating an absence of motion based on the identified peak cross-correlation level exceeding the correlation degree threshold.

In other implementations, the method can determine the difference by determining an amount of multipath of the first frame based on the first CIR, determining an amount of multipath of the second frame based on the second CIR, and determining a difference between the amount of multipath of the first frame and the amount of multipath of the second frame. In some aspects, the method can also include indicating a presence of motion based on the difference exceeding a value, and indicating an absence of motion based on the difference not exceeding the value.

Another innovative aspect of the subject matter described in this disclosure can be implemented in an apparatus. The apparatus can include one or more processors and a memory storing instructions. Execution of the instructions by the one or more processors can cause the apparatus to receive a first frame and a second frame from a transmitting device, to determine a first channel impulse response (CIR) based on the first frame, to determine a second CIR based on the second frame, to determine a difference between a shape of the first CIR and a shape of the second CIR, and to detect motion based on the determined difference. In some implementations, execution of the instructions can further cause the apparatus to indicate a presence of motion based on the difference exceeding a value, and to indicate an absence of motion based on the difference not exceeding the value.

Another innovative aspect of the subject matter described in this disclosure can be implemented in a non-transitory computer-readable storage medium. The non-transitory computer-readable storage medium can store instructions that, when executed by one or more processors of a wireless device, cause the wireless device to perform a number of operations. The number of operations can include receiving a first frame and a second frame from a transmitting device, determining a first channel impulse response (CIR) based on the first frame, determining a second CIR based on the second frame, determining a difference between a shape of the first CIR and a shape of the second CIR, and detecting motion based on the determined difference. In some implementations, the number of operations can also include indicating a presence of motion based on the difference exceeding a value, and indicating an absence of motion based on the difference not exceeding the value.

Another innovative aspect of the subject matter described in this disclosure can be implemented in a wireless device. The wireless device can include means for receiving a first frame and a second frame from a transmitting device, means for determining a first channel impulse response (CIR) based on the first frame, means for determining a second CIR based on the second frame, means for determining a difference between a shape of the first CIR and a shape of the second CIR, and means for detecting motion based on the determined difference. In some implementations, the means for detecting motion can indicate a presence of motion based on the difference exceeding a value, and can indicate an absence of motion based on the difference not exceeding the value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of a wireless system.

FIG. 2 shows a block diagram of an access point.

FIG. 3 shows a block diagram of a wireless device.

FIG. 4A shows a transmission of a multipath wireless signal in a room without motion.

FIG. 4B shows a transmission of a multipath wireless signal in a room with motion.

FIG. 4C shows another transmission of a multipath wireless signal in a room with motion.

FIG. 5A shows an example channel impulse response of the multipath wireless signal of FIG. 4A.

FIG. 5B shows an example channel impulse response of the multipath wireless signal of FIG. 4B.

FIG. 6 shows an example ranging operation.

FIG. 7 shows another example ranging operation.

FIG. 8A shows an example fine timing measurement (FTM) request frame.

FIG. 8B shows an example FTM action frame.

FIG. 9 shows an example FTM parameters field.

FIG. 10A shows an example CIR power profile before alignment.

FIG. 10B shows an example CIR power profile after alignment.

FIG. 11A is a plot depicting two example CIR power profiles before alignment in time with each other.

FIG. 11B is a plot of an example cross-correlation result.

FIG. 11C is a plot depicting two example CIR power profiles after alignment in time with each other.

FIG. 12 shows an illustrative flow chart depicting an example operation for detecting motion.

FIG. 13A shows an illustrative flow chart depicting an example operation for determining a difference between first and second channel impulse responses.

FIG. 13B shows an illustrative flow chart depicting another example operation for determining a difference between first and second channel impulse responses.

FIG. 14 shows an illustrative flow chart depicting another example operation for detecting motion.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network. Such systems or network are capable of transmitting and receiving RF signals. The transmission and reception of the signals may be according to any of the IEEE 802.16 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Given the increasing number of IoT devices deployed in home and business networks, it is desirable to detect motion of objects or people in such networks. For example, one or more IoT devices can be turned on or off when a person enters or leaves a room or a space. However, because using motion sensors in such systems and networks can increase costs and complexity, it would be desirable to detect motion without using motion sensors.

Implementations of the subject matter described in this disclosure may be used to detect motion using wireless RF signals rather than using an optical, ultrasonic, microwave or infrared motion sensing detectors. For some implementations, a first device may receive first and second frames from a second device, and may determine a channel impulse response (CIR) for each of the first and second frames. The first device may detect motion based on differences between the CIR of the first frame and the CIR of the second frame. In some implementations, the first device may compare a difference between a CIR magnitude profile of the first frame and a CIR magnitude profile of the second frame with a threshold level to determine a presence or absence of motion. In other implementations, the first device may compare a difference between a CIR power profile of the first frame and a CIR power profile of the second frame with a threshold level to determine a presence or absence of motion.

In some other implementations, the first device may determine a presence or absence of motion based an amount of multipath of a wireless signal received from the second device. The wireless signal may include multipath signals associated with multiple arrival paths, and the detection of motion can be based on at least one characteristic of the multipath signals. In some aspects, the first device can detect motion by determining an amount of multipath of the received wireless signal, comparing the determined amount of multipath with a reference amount, and indicating a presence of motion based on the determined amount of multipath differing from the reference amount by more than a value. In some aspects, the first device can determine the amount of multipath by determining a channel impulse response (CIR) of the wireless signal, and determining a root mean square (RMS) value of a duration of the CIR. In other aspects, the first device can determine the amount of multipath by determining a CIR of the wireless signal, identifying a first tap and a last tap of the determined CIR, and determining a duration between the first tap and the last tap.

As used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax or 802.11az standards.

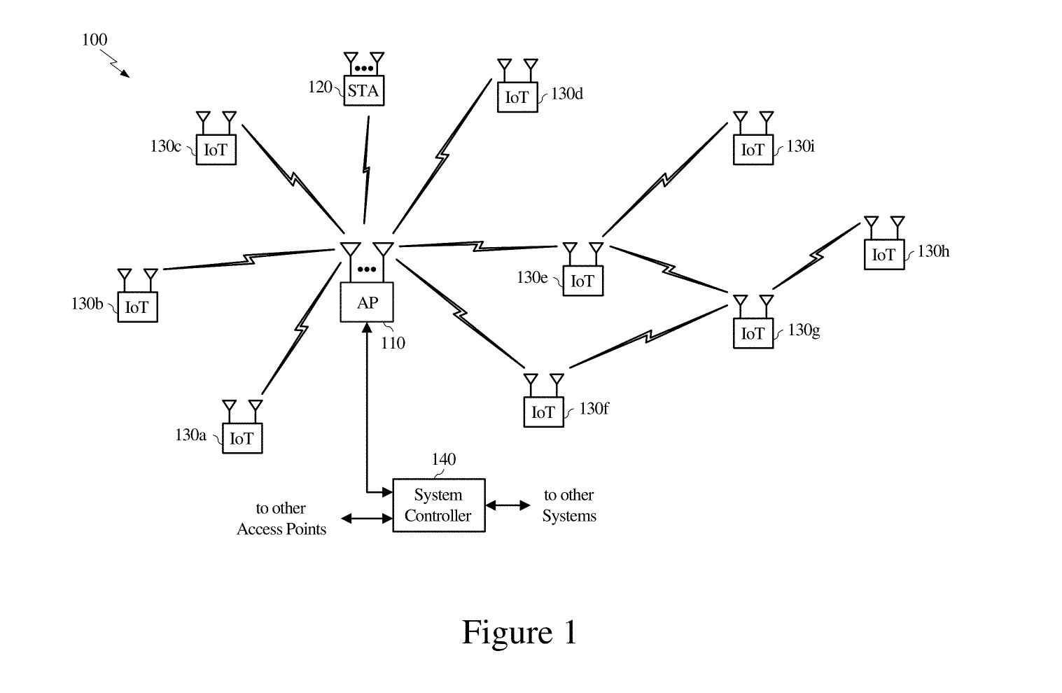

FIG. 1 shows a block diagram of an example wireless system 100. The wireless system 100 is shown to include a wireless access point (AP) 110, a wireless station (STA) 120, a plurality of Internet of Things (IoT) devices 130a-130h, and a system controller 140. For simplicity, only one AP 110 and only one STA 120 are shown in FIG. 1. The AP 110 may form a wireless local network (WLAN) that allows the AP 110, the STA 120, and the IoT devices 130a-130i to communicate with each other over a wireless medium. The wireless medium, which may be divided into a number of channels, may facilitate wireless communications via Wi-Fi signals (such as according to the IEEE 802.11 standards), via Bluetooth signals (such as according to the IEEE 802.15 standards), and other suitable wireless communication protocols. In some aspects, the STA 120 and the IoT devices 130a-130i can communicate with each other using peer-to-peer communications (such as without the presence or involvement of the AP 110).

In some implementations, the wireless system 100 may correspond to a multiple-input multiple-output (MIMO) wireless network, and may support single-user MIMO (SU-MIMO) and multi-user (MU-MIMO) communications. Further, although the wireless system 100 is depicted in FIG. 1 as an infrastructure Basic Service Set (BSS), in other implementations, the wireless system 100 may be an Independent Basic Service Set (IBSS), an Extended Basic Service Set, an ad-hoc network, a peer-to-peer (P2P) network (such as operating according to the Wi-Fi Direct protocols), or a mesh network. Thus, for at least some implementations, the AP 110, the STA 120, and the IoT devices 130a-130i can communicate with each other using multiple wireless communication protocols (such as Wi-Fi signals and Bluetooth signals).

The STA 120 may be any suitable Wi-Fi enabled wireless device including, for example, a cell phone, personal digital assistant (PDA), tablet device, laptop computers, or the like. The STA 120 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, STA 120 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described herein.

Each of IoT devices 130a-130i may be any suitable device capable of operating according to one or more communication protocols associated with IoT systems. For example, the IoT devices 130a-130i can be a smart television, a smart appliance, a smart meter, a smart thermostat, a sensor, a gaming console, a set-top box, a smart light switch, and the like. In some implementations, the IoT devices 130a-130i can wirelessly communicate with each other, mobile station, access points, and other wireless devices using Wi-Fi signals, Bluetooth signals, and WiGig signals. For at least some implementations, each of IoT devices 130a-130i may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described herein. In some implementations, each of the IoT devices 130a-130i may include fewer wireless transmission resources than the STA 120. Another distinction between STA 120 and the IoT devices 130a-130i may be that the IoT devices 130a-130i typically communicate with other wireless devices using relatively narrow channel widths (such as to reduce power consumption), while the STA 120 typically communicates with other wireless devices using relatively wide channel widths (such as to maximize data throughput). In some aspects, the IoT devices 130a-130i may communicate using narrowband communication protocols such as Bluetooth Low Energy (BLE). The capability of a device to operate an as IoT may be made possible by electronically attaching a transceiver card to the device. The transceiver card may be removable, and thus allowing the device to operate as an IoT for the time that the transceiver card is operating and interacting with the device and other IoT devices. For example, a television set with receptors to receive electronically such a transceiver card may be operate as an IoT when such a transceiver card has been attached and operating to communicate wireless signals with other IoT devices.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below. For other implementations, one or more functions of AP 110 may be performed by the STA 120 (such as operating as a soft AP). A system controller 140 may provide coordination and control for the AP 110 and/or for other APs within or otherwise associated with the wireless system 100 (other access points not shown for simplicity).

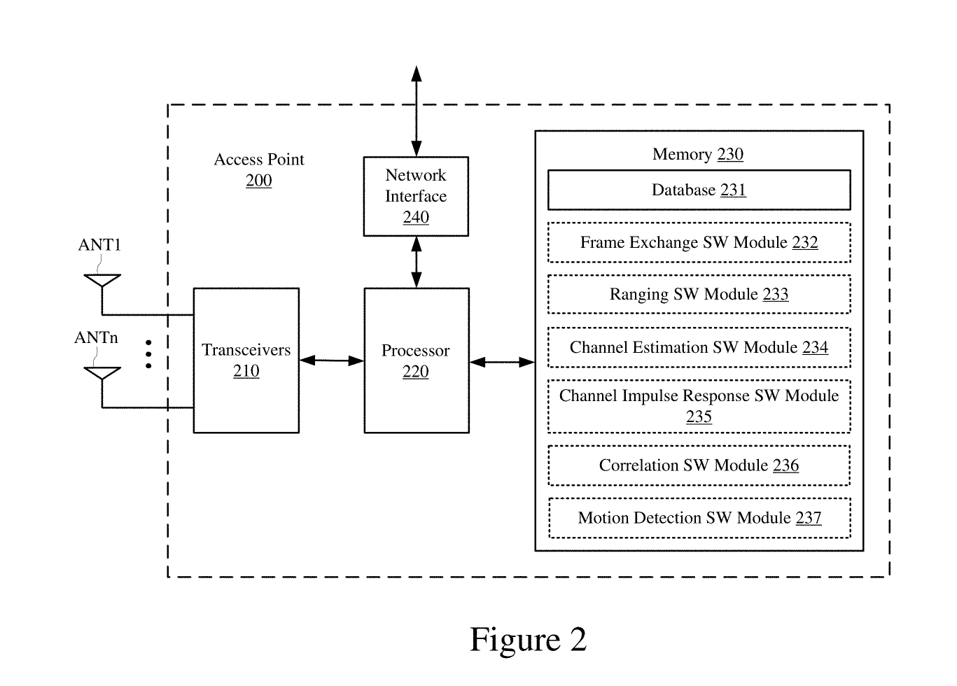

FIG. 2 shows an example access point 200. The access point (AP) 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, the IoT devices 130a-130i and STA 120 of FIG. 1, or other suitable wireless devices. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. Thus, the AP 200 may be configured for MIMO operations. The MIMO operations may include SU-MIMO operations and MU-MIMO operations. Further, in some aspects, the AP 200 may use multiple antennas ANT1-ANTn to provide antenna diversity. Antenna diversity may include polarization diversity, pattern diversity, and spatial diversity.

For purposes of discussion herein, processor 220 is shown as coupled between transceivers 210 and memory 230. For actual implementations, transceivers 210, processor 220, the memory 230, and the network interface 240 may be connected together using one or more buses (not shown for simplicity). The network interface 240 can be used to connect the AP 200 to one or more external networks, either directly or through the system controller 140 of FIG. 1.

Memory 230 may include a database 231 that may store location data, configuration information, data rates, MAC addresses, timing information, modulation and coding schemes, and other suitable information about (or pertaining to) a number of IoT devices, stations, and other APs. The database 231 also may store profile information for a number of wireless devices. The profile information for a given wireless device may include, for example, the wireless device's service set identification (SSID), channel information, received signal strength indicator (RSSI) values, throughput values, channel state information (CSI), and connection history with the access point 200.

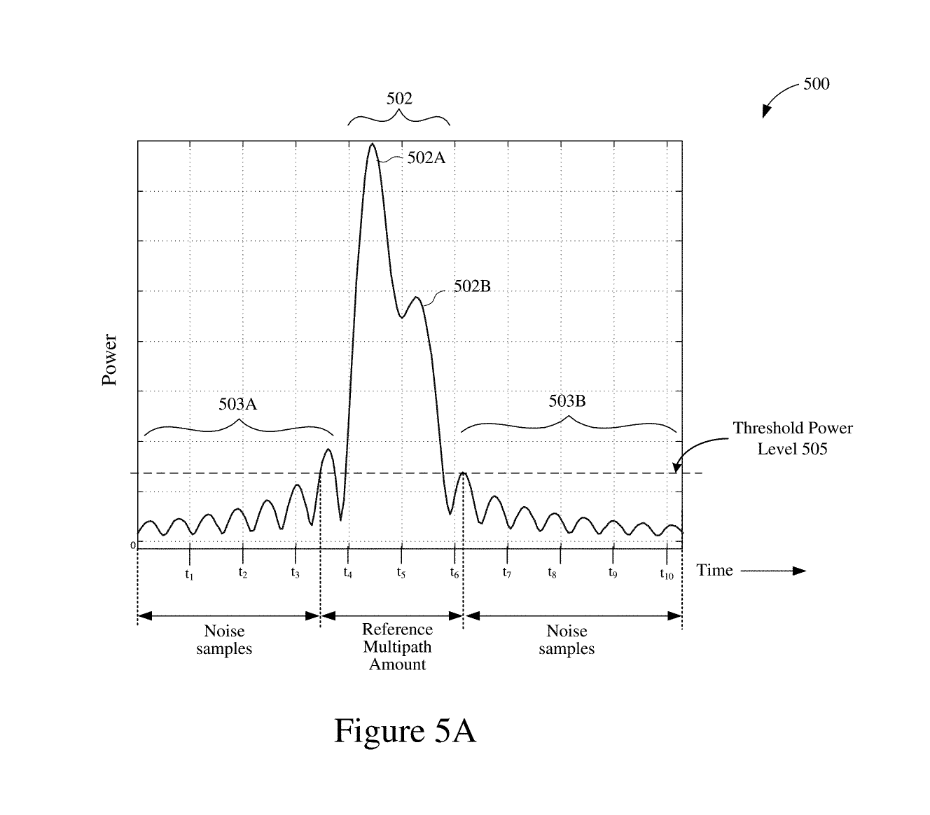

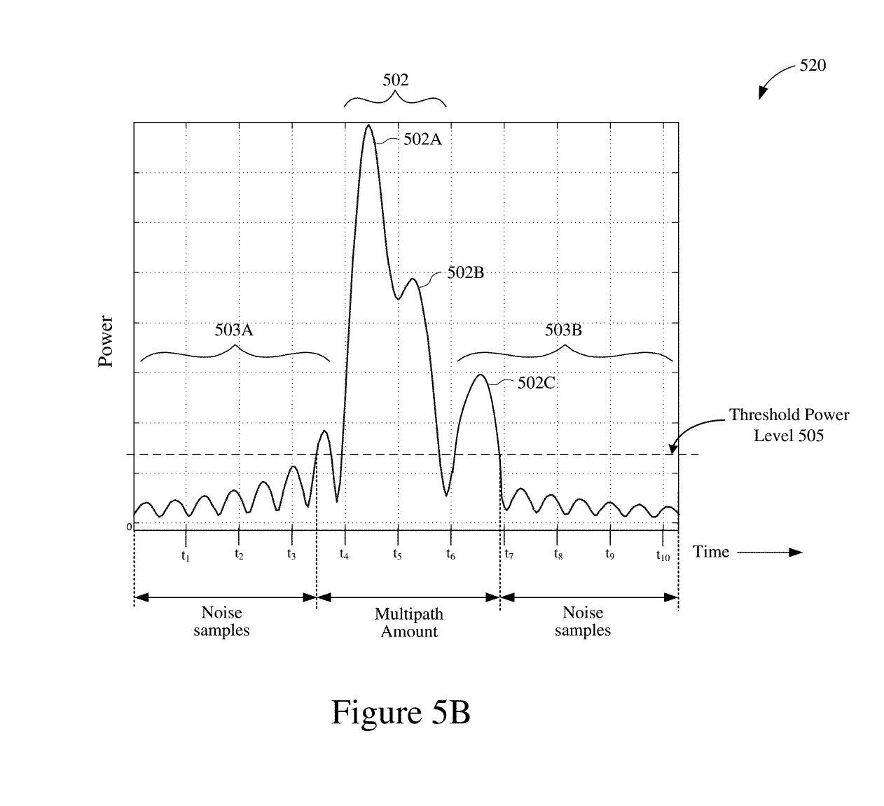

Memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange frames (such as data frames, control frames, management frames, and action frames) between AP 200 and other wireless devices, for example, as described with respect to FIGS. 5A-5B, 6, 7, 10A-10B, 11A-11C, 12, 13A-13B, and 14;
a ranging software module 233 to perform a number of ranging operations with one or more other devices, for example, as described with respect to FIGS. 5A-5B, 6, 7, 10A-10B, 11A-11C, 12, 13A-13B, and 14;
a channel estimation software module 234 to estimate channel conditions and to determine a channel frequency response based on wireless signals transmitted from other devices, for example, as described with respect to FIGS. 5A-5B, 6, 7, 10A-10B, 11A-11C, 12, 13A-13B, and 14;
a channel impulse response (CIR) software module 235 to determine or derive a CIR based, at least in part, on the estimated channel conditions or the channel frequency response provided by the channel estimation software module 234, for example, as described with respect to FIGS. 5A-5B, 6, 7, 10A-10B, 11A-11C, 12, 13A-13B, and 14;
a correlation software module 236 to determine an amount of correlation between a number of channel impulse responses, for example, as described with respect to FIGS. 5A-5B, 6, 7, 10A-10B, 11A-11C, 12, 13A-13B, and 14; and
a motion detection module 237 to detect or determine a presence of motion in the vicinity of the AP 200 based at least in part on the estimated channel conditions and/or the determined amount of correlation between the channel impulse responses, for example, as described with respect to FIGS. 5A-5B, 6, 7, 10A-10B, 11A-11C, 12, 13A-13B, and 14.

Each software module includes instructions that, when executed by the processor 220, may cause the AP 200 to perform the corresponding functions. The non-transitory computer-readable medium of the memory 230 thus includes instructions for performing all or a portion of the operations described with respect to FIGS. 5A-5B, 6, 7, 10A-10B, 11A-11C, 12, 13A-13B, and 14.

The processor 220 may be any one or more suitable processors capable of executing scripts or instructions of one or more software programs stored in the AP 200 (such as within memory 230). For example, the processor 220 may execute the frame exchange software module 232 to create and exchange frames (such as data frames, control frames, management frames, and action frames) between the AP 200 and other wireless devices. The processor 220 may execute the ranging software module 233 to perform a number of ranging operations with one or more other devices. The processor 220 may execute the channel estimation software module 234 to estimate channel conditions and to determine a channel frequency response of wireless signals transmitted from other devices.

The processor 220 may execute the channel impulse response software module 235 to determine or derive a CIR based, at least in part, on the estimated channel conditions or the channel frequency response provided by the channel estimation software module 234. In some implementations, the processor 220 may execute the channel impulse response software module 235 to determine or derive a first CIR for a first frame received from a transmitting device, and to determine or derive a second CIR for a second frame received from the transmitting device. In some aspects, the first frame and the second frame may be received in the same wireless signal. In other aspects, the first frame may be received in a first wireless signal, and the second frame may be received in a second wireless signal distinct from the first wireless signal CIR. In addition, or in the alternative, the processor 220 may execute the channel impulse response software module 235 to determine a CIR power profile or a CIR magnitude profile for each of the determined channel impulse responses (or for each of the first and second frames).

The processor 220 may execute the correlation software module 236 to determine an amount of correlation between a number of channel impulse responses. In some implementations, the processor 220 may execute the correlation software module 236 to determine a correlation between amounts of multipath in a plurality of channel impulse responses of wireless signals or individual frames. In other implementations for which the first CIR is a CIR magnitude profile of the first frame and the second CIR is a CIR magnitude profile of the second frame, the processor 220 may execute the correlation software module 236 to determine a plurality of cross-correlation levels between the CIR magnitude profile of the first frame and the CIR magnitude profile of the second frame, to identify a peak cross-correlation level from the plurality of determined cross-correlation levels, and to compare the identified peak cross-correlation level with a correlation degree threshold.

In some implementations, the processor 220 may execute the motion detection software module 237 to detect or determine a presence of motion in the vicinity of the AP 200 based at least in part on the estimated channel conditions or the determined amount of correlation between the channel impulse responses. In other implementations, the processor 220 may execute the motion detection software module 237 to detect or determine a presence of motion in the vicinity of the AP 200 based on a difference between a shape of the first CIR and a shape of the second CIR. In some other implementations, the processor 220 may execute the motion detection software module 237 to detect or determine a presence of motion in the vicinity of the AP 200 based on the identified peak cross-correlation level not exceeding the correlation degree threshold.

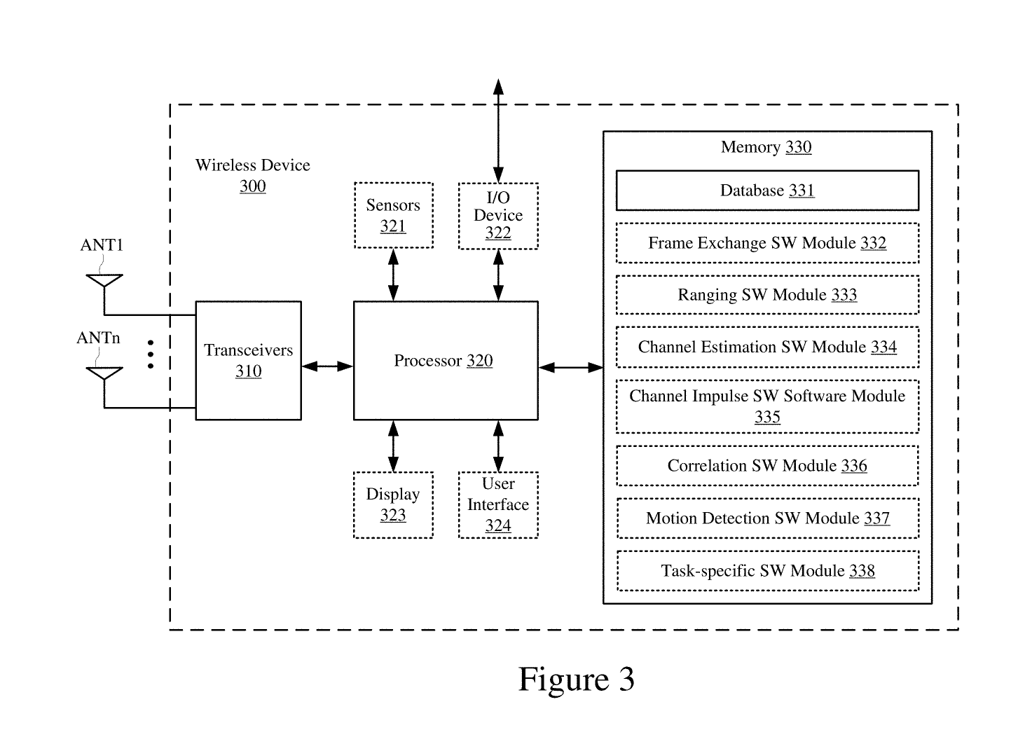

FIG. 3 shows an example block diagram of a wireless device 300. The wireless device 300 may be one implementation of STA 120 or any one of the IoT devices 130a-130i of FIG. 1. The wireless device 300 includes one or more transceivers 310, a processor 320, a memory 330, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from APs, STAs, other IoT devices, or any other suitable wireless device. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. For purposes of discussion herein, processor 320 is shown as coupled between transceivers 310 and memory 330. For actual implementations, transceivers 310, processor 320, and memory 330 may be connected together using one or more buses (not shown for simplicity).

The wireless device 300 may optionally include one or more of sensors 321, an input/output (I/O) device 322, a display 323, a user interface 324, and any other suitable component. For one example in which the wireless device 300 is a smart television, the display 323 may be a TV screen, the I/O device 324 may provide audio-visual inputs and outputs, the user interface 324 may be a control panel, a remote control, and so on. For another example in which the wireless device 300 is a smart appliance, the display 323 may provide status information, and the user interface 324 may be a control panel to control operation of the smart appliance. The functions performed by such IoT devices may vary in complexity and function. As such, one or more functional blocks shown in the wireless device 300 may not be present and/or additional functional blocks may be present.

In some implementations, an IoT device may be implemented with minimal hardware and software complexity. For example, an IoT device functioning as a light switch may have far less complexity than an IoT device implemented for a smart television. Moreover, any possible device may be converted into an IoT device by electronically connecting to a removable electronic card which includes one or more functionalities shown in FIG. 3. The device would functionally interact with the electronic card. For example, an older generation television set could be converted to a smart television by inserting the electronic card in an input port of the television, and allowing the electronic card to interact with the operation of the television.

Memory 330 may include a database 331 that stores profile information for a plurality of wireless devices such as APs, stations, and/or other wireless devices. The profile information for a particular AP may include information including, for example, the AP's SSID, MAC address, channel information, RSSI values, certain parameters values, channel state information (CSI), supported data rates, connection history with the AP, a trustworthiness value of the AP (e.g., indicating a level of confidence about the AP's location, etc.), and any other suitable information pertaining to or describing the operation of the AP. The profile information for a particular IoT device or station may include information including, for example, device's MAC address, IP address, supported data rates, and any other suitable information pertaining to or describing the operation of the device.

Memory 330 also may include a non-transitory computer-readable storage medium (such as one or more nonvolatile memory elements, such as EPROM, EEPROM, Flash memory, a hard drive, and so on) that may store the following software (SW) modules:
a frame exchange software module 332 to create and exchange frames (such as data frames, control frames, management frames, and action frames) between the wireless device 300 and other wireless devices, for example, as described with respect to FIGS. 5A-5B, 6, 7, 10A-10B, 11A-11C, 12, 13A-13B, and 14;
a ranging software module 333 to perform a number of ranging operations with one or more other devices, for example, as described with respect to FIGS. 5A-5B, 6, 7, 10A-10B, 11A-11C, 12, 13A-13B, and 14;
a channel estimation software module 334 to estimate channel conditions and to determine a channel frequency response based on wireless signals transmitted from other devices, for example, as described with respect to FIGS. 5A-5B, 6, 7, 10A-10B, 11A-11C, 12, 13A-13B, and 14;
a channel impulse response software module 335 to determine or derive a channel impulse response based, at least in part, on the estimated channel conditions and/or the channel frequency response provided by the channel estimation software module 334, for example, as described with respect to FIGS. 5A-5B, 6, 7, 10A-10B, 11A-11C, 12, 13A-13B, and 14;
a correlation software module 336 to determine an amount of correlation between a number of channel impulse responses, for example, as described with respect to FIGS. 5A-5B, 6, 7, 10A-10B, 11A-11C, 12, 13A-13B, and 14;
a motion detection software module 337 to detect or determine a presence of motion in the vicinity of the wireless device 300 based at least in part on the estimated channel conditions and/or the determined amount of correlation between the channel impulse responses, for example, as described with respect to FIGS. 5A-5B, 6, 7, 10A-10B, 11A-11C, 12, 13A-13B, and 14; and
a task-specific software module 338 to facilitate the performance of one or more tasks that may be specific to the wireless device 300.

Each software module includes instructions that, when executed by processor 320, may cause the wireless device 300 to perform the corresponding functions. The non-transitory computer-readable medium of memory 330 thus includes instructions for performing all or a portion of the operations described with respect to FIGS. 5A-5B, 6, 7, 10A-10B, 11A-11C, 12, 13A-13B, and 14.

The processor 320 may be any one or more suitable processors capable of executing scripts or instructions of one or more software programs stored in the wireless device 300 (such as within memory 330). For example, the processor 320 may execute the frame exchange software module 332 to create and exchange frames (such as data frames, control frames, management frames, and action frames) between the wireless device 300 and other wireless devices. The processor 320 may execute the ranging software module 333 to perform a number of ranging operations with one or more other devices. The processor 320 may execute the channel estimation software module 334 to estimate channel conditions and to determine a channel frequency response of wireless signals transmitted from other devices.

The processor 320 may execute the channel impulse response software module 335 to determine or derive a CIR based, at least in part, on the estimated channel conditions and/or the channel frequency response provided by the channel estimation software module 334. In some implementations, the processor 320 may execute the channel impulse response software module 335 to determine or derive a first CIR for a first frame received from a transmitting device, and to determine or derive a second CIR for a second frame received from the transmitting device. In some aspects, the first frame and the second frame may be received in the same wireless signal. In other aspects, the first frame may be received in a first wireless signal, and the second frame may be received in a second wireless signal distinct from the first wireless signal CIR. In addition, or in the alternative, the processor 320 may execute the channel impulse response software module 335 to determine a CIR power profile or a CIR magnitude profile for each of the determined channel impulse responses (or for each of the first and second frames).

The processor 320 may execute the correlation software module 336 to determine an amount of correlation between a number of channel impulse responses. In some implementations, the processor 320 may execute the correlation software module 336 to determine a correlation between amounts of multipath in a plurality of channel impulse responses of wireless signals or individual frames. In other implementations for which the first CIR is a CIR magnitude profile of the first frame and the second CIR is a CIR magnitude profile of the second frame, the processor 320 may execute the correlation software module 336 to determine a plurality of cross-correlation levels between the CIR magnitude profile of the first frame and the CIR magnitude profile of the second frame, to identify a peak cross-correlation level from the plurality of determined cross-correlation levels, and to compare the identified peak cross-correlation level with a correlation degree threshold.

In some implementations, the processor 320 may execute the motion detection software module 337 to detect or determine a presence of motion in the vicinity of the wireless device 300 based at least in part on the estimated channel conditions or the determined amount of correlation between the channel impulse responses. In other implementations, the processor 320 may execute the motion detection software module 337 to detect or determine a presence of motion in the vicinity of the wireless device 300 based on a difference between a shape of the first CIR and a shape of the second CIR. In some other implementations, the processor 320 may execute the motion detection software module 337 to detect or determine a presence of motion in the vicinity of the wireless device 300 based on the identified peak cross-correlation level not exceeding the correlation degree threshold.

The processor 320 may execute the task-specific software module 338 to facilitate the performance of one or more tasks that may be specific to the wireless device 300. For one example in which the wireless device 300 is a smart TV, execution of the task specific software module 338 may cause the smart TV to turn on and off, to select an input source, to select an output device, to stream video, to select a channel, and so on. For another example in which the wireless device 300 is a smart thermostat, execution of the task specific software module 338 may cause the smart thermostat to adjust a temperature setting in response to one or more signals received from a user or another device. For another example in which the wireless device 300 is a smart light switch, execution of the task specific software module 338 may cause the smart light switch to turn on/off or adjust a brightness setting of an associated light in response to one or more signals received from a user or another device. In some implementations, execution of the task-specific software module 338 may cause the wireless device 300 to turn on and off based on a detection of motion, for example, by the motion detection software module 337.

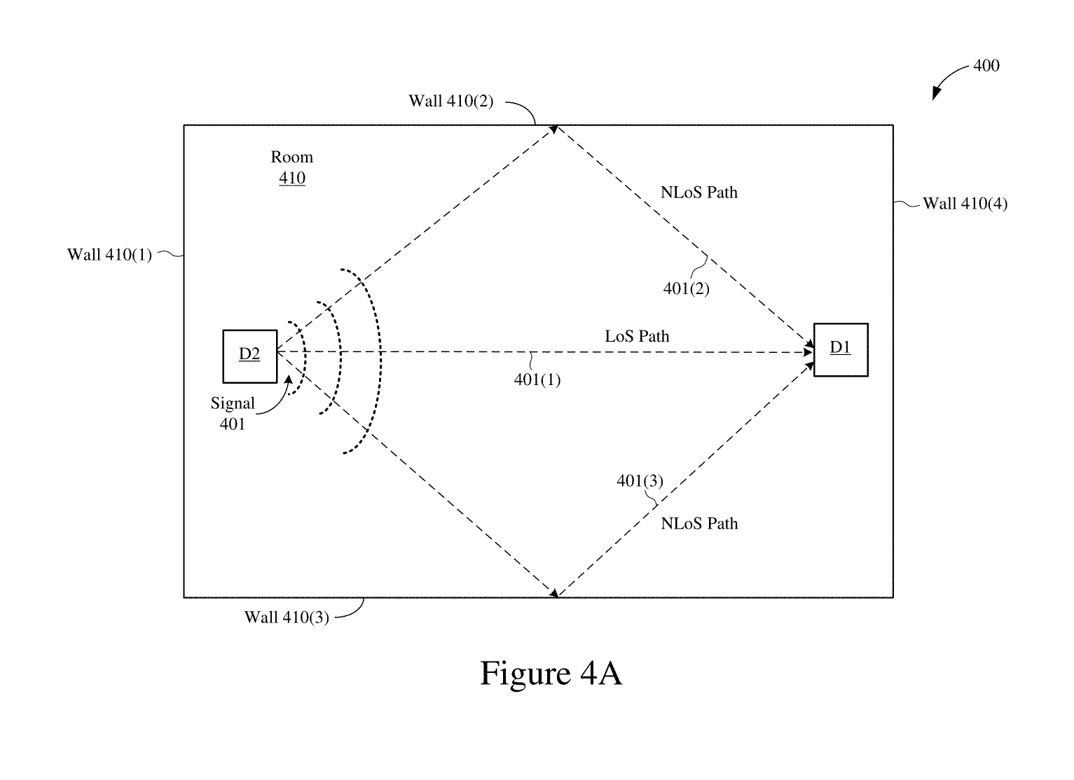

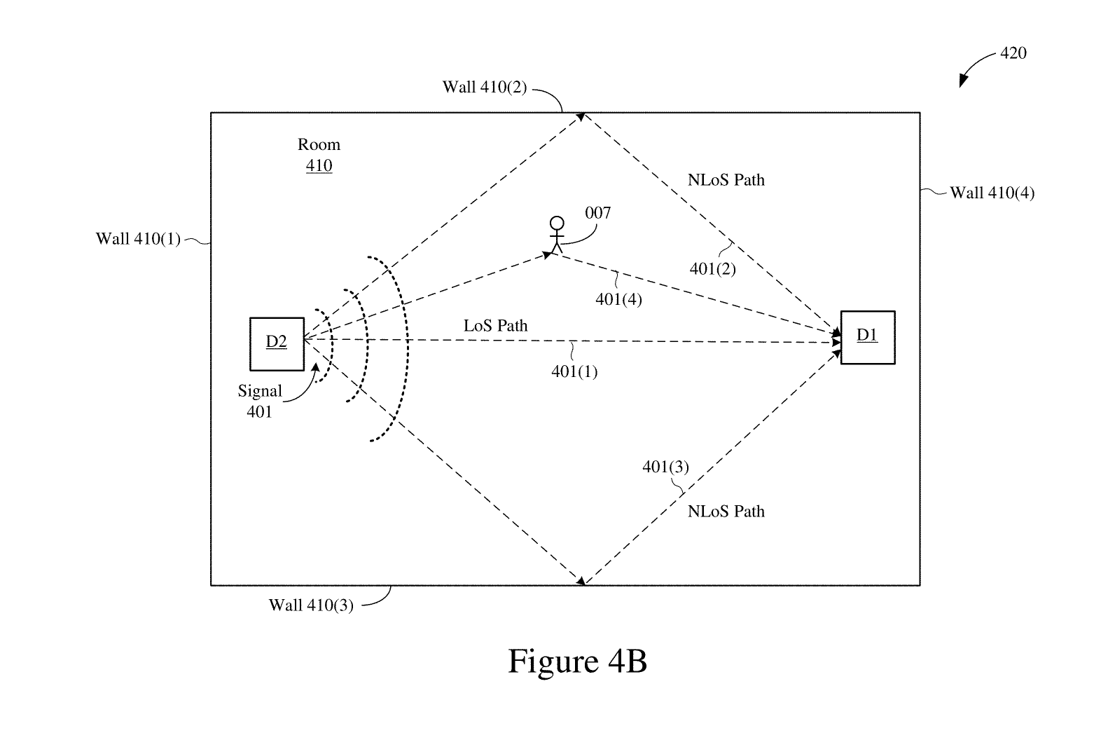

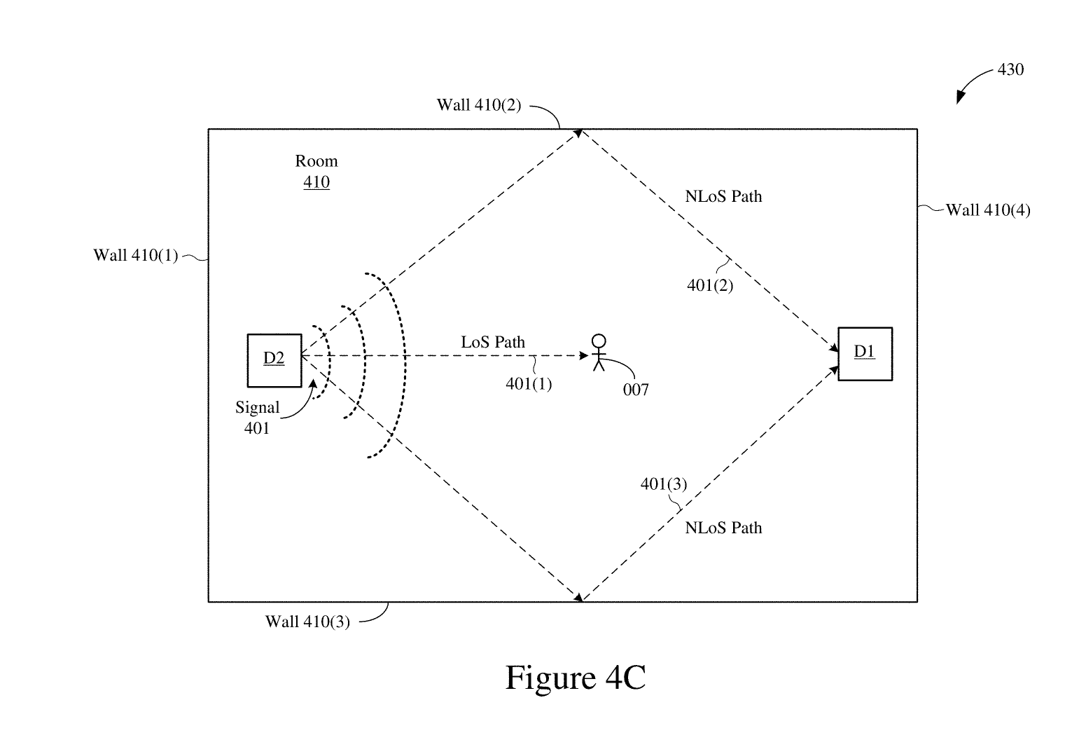

FIG. 4A shows a transmission of a multipath wireless signal 401 in a room 410 without motion. As depicted in FIG. 4A, a first device D1 receives a wireless signal 401 transmitted from a second device D2. The wireless signal 401 may be any suitable wireless signal from which channel conditions can be estimated including, for example, a data frame, a beacon frame, a probe request, an ACK frame, a timing measurement (TM) frame, a fine timing measurement (FTM) frame, a null data packet, and so on. In a signal propagation space where objects and/or walls are in the vicinity of the source of the signal transmission, certain multipath effect would be experienced. The receiving end of the signal would invariably experience receiving the transmitted signal through such multipath effect. In the example of room 410, the wireless signal 401 may be influenced by multipath effects. The effects may be due, for example, from at least walls 410(2) and 410(3) and other obstacles and objects, such as furniture. For simplicity, the multipath effect is shown to produce a first signal component 401(1), a second signal component 401(2), and a third signal component 401(3). The first signal component 401(1) travels directly from device D2 to device D1 along a line-of-sight (LOS) path, the second signal component 401(2) travels indirectly from device D2 to device D1 along a non-LOS (NLOS) path that reflects off wall 410(2), and the third signal component 401(3) travels indirectly from device D2 to device D1 along a NLOS path that reflects off wall 410(3). As a result, the first signal component 401(1) may arrive at device D1 at different times or at different angles compared to the second signal component 401(2) or the third signal component 401(3).

It is noted that although only two NLOS signal paths are depicted in FIG. 4A, the wireless signal 401 may have any number of signal components that travel along any number of NLOS paths between device D2 and device D1. Further, although the first signal component 401(1) is depicted as being received by device D1 without intervening reflections, for other examples, the first signal component 401(1) may be reflected one or more times before received by device D1.

As mentioned above, it would be desirable for device D1 to detect motion in its vicinity (such as within the room 410) without using a separate or dedicated motion sensor. Thus, in accordance with various aspects of the present disclosure, device D1 can use the wireless signal 401 transmitted from device D2 to detect motion within the room 410. More specifically, device D1 can estimate channel conditions based at least in part on the wireless signal 401, and then detect motion based at least in part on the estimated channel conditions. Thereafter, device D1 can perform a number of operations based on the detected motion. For example, device D1 can turn itself on when motion is detected, and can turn itself off when motion is not detected for a time period. In yet another example, it may simply alert a user about detection of motion in room 410.

As depicted in FIG. 4A, the wireless signal 401 includes multipath signals 401(1)-401(3) associated with multiple arrival paths. As a result, the detection of motion in room 410 may be based on at least one characteristic of the multipath signals 401(1)-401(3). For purposes of discussion herein, there is no motion in room 410 at the time depicted in FIG. 4A (such as a night when no one is in the room 410 or during times when no one is at home or walking through room 410). For purposes of discussion herein, the signal propagation of the signal 401 in the room 410 depicted in FIG. 4A may be associated with an observation at a first time T1 when no motion is expected to be occurring in the room 410. In some implementations, device D1 estimates channel conditions when there is no motion in the room 410, and then designates these estimated channel conditions as reference channel conditions. The reference channel conditions can be stored in device D1 or in any other suitable device coupled to device D1, for example, as occurring at the first time T1. It is noted that device D1 can estimate or determine the reference channel conditions continuously, periodically, randomly, or at one or more specified times (such as when there is no motion in the room 410).

FIG. 5A shows an example channel impulse response (CIR) 500 of the wireless signal 401. The channel impulse response 500 may be expressed in terms of power (y-axis) as a function of time (x-axis). As described above with respect to FIG. 4A, the wireless signal 401 includes line-of-sight (LOS) signal components 401(1) and non-LOS (NLOS) signal components 401(2)-401(3), and is received by device D1 in the presence of multipath effects. In some implementations, device D1 may determine the CIR 500 by taking an Inverse Fourier Transfer (IFT) function of a channel frequency response of the received wireless signal 401. Thus, in some aspects, the channel impulse response 500 may be a time-domain representation of the wireless signal 401 of FIG. 4A. Because the wireless signal 401 of FIG. 4A includes a LOS signal component 401(1) and a number of NLOS signal components 401(2)-401(3), the CIR 500 of FIG. 5A may be a superposition of multiple sinc pulses, each associated with a corresponding peak or “tap” at a corresponding time value.

More specifically, the CIR 500 is shown to include a main lobe 502 occurring between approximately times t₄ and t₆, and includes a plurality of secondary lobes 503A and 503B on either side of the main lobe 502. The main lobe 502 includes a first peak 502A and a second peak 502B of different magnitudes, for example, caused by multipath effects. The first peak 502A, which has a greater magnitude than the second peak 502B, may represent the signal components traveling along the first arrival path (FAP) to device D1 of FIG. 4A. In some aspects, the main peak 502A may be the first arrival in the CIR 500, and may represent the LOS signal components as well as one or more NLOS signal components that may arrive at device D1 at the same time (or nearly the same time) as the LOS signal components. The taps associated with secondary lobes 503A and 503B may be later arrivals in the CIR 500, and may represent the NLOS signal components arriving at device D1.

As shown in FIG. 5A, a threshold power level 505 may be selected for the CIR 500, and the portion of the CIR 500 that exceeds the threshold power level 505 may be designated as the amount of multipath in the received signal 401. In other words, for the example of FIG. 5A, the amount of multipath may be expressed as the duration of the CIR 500 that exceeds the threshold power level 505. Portions of the CIR 500 associated with later signal arrivals that fall below the threshold power level 505 may be designated as noise samples of the received signal 401. The amount of multipath determined from the CIR 500 of FIG. 5A may be stored in device D1 (or another suitable device) as a reference multipath amount and thereafter used to detect motion in the room 410 at other times.

In some aspects, the amount of multipath can be measured as the Root Mean Square (RMS) of channel delay (such as the duration of multipath that is longer than a threshold). The duration of the multipath is the width (or time delay) of the entire CIR 500, and while only portions of the CIR 500 corresponding to the first arrival path are typically used when estimating angle information of a wireless signal, the entire CIR 500 may be used when detecting motion based on a wireless signal as disclosed herein. The threshold power level 505 may be set according to the power level of the strongest signal path, to the noise power, or to a combination thereof.

The device D1 may use the reference multipath amount determined at time T1 to detect motion in the room 410 at one or more later times. For example, FIG. 4B shows the transmission of a multipath wireless signal 401 in the room 410 with motion. For purposes of discussion herein, the room 410 depicted in FIG. 4B may be associated with multipath signal propagation occurring at a second time T2. As depicted in FIG. 4B, a person 007 has entered the room 410 and caused at least an additional NLOS signal component 401(4) of the wireless signal 401. The additional NLOS signal component 401(4) resulting from the presence or movement of person 007 may change the channel conditions of the room 410, for example, as compared to the channel conditions of the room 410 at the first time T1 (as depicted in FIG. 4A). In accordance with various aspects of the present disclosure, device D1 may use changes in estimated channel conditions between times T1 and T2 to detect movement of an object/person (such as motion) in the room 410. More specifically, device D1 may estimate channel conditions based on the signal 401 of FIG. 4B (which includes the “new” NLOS signal component 401(4)), and may compare the estimated channel conditions at the second time T2 with the reference channel conditions estimated at the first time T1.

FIG. 5B shows an example CIR 520 of the wireless signal 401 at time T2. The CIR 520 is similar to the CIR 500 of FIG. 5A, except that the multipath amount at time T2 is greater (such as having a longer duration) than the reference multipath amount depicted in FIG. 5A, and the CIR 520 includes an extra peak 502C corresponding to the NLOS signal component 401(4) caused by the presence or movement of person 007 in the room 410. Thus, in some aspects, the change in multipath amount between time T1 and time T2 may be used to detect motion in the vicinity of device D1 (such as in the room 410).

FIG. 4C shows the transmission of a multipath wireless signal 401 in the room 410 when the person 007 obstructs the LOS signal component 401(1) at a third time T3. As shown in FIG. 4C, the location of the person 007 may prevent the wireless signal 401 from having a LOS signal component 401(1) that reaches device D1. The absences of the LOS signal component 401(1) may cause the channel conditions at time T3 to be different from the channel conditions at time T2 (see FIG. 4B) and to be different from the channel conditions at time T1 (see FIG. 4A). Device D1 may use changes in estimated channel conditions between either times T1 and T3 or between times T2 and T3 (or a combination of both) to detect motion in the room 410. Thus, in some aspects, device D1 may estimate channel conditions based on the signal 401 of FIG. 4C, and may compare the estimated channel conditions at time T3 with the reference channel conditions estimated at time T1 to detect motion in the room 410. In other aspects, device D1 may estimate channel conditions based on the received signal 401 of FIG. 4C, and may compare the estimated channel conditions at time T3 with the channel conditions estimated at time T2 to detect motion in the room 410.

In other implementations, device D1 may use the first arrival path (FAP) of the CIR 520 to detect motion when the person 007 blocks LOS signal components of the multipath signal 401, for example, as depicted in FIG. 4C. More specifically, device D1 may determine whether the power level of the FAP signal component has changed by more than a threshold value, for example, by comparing the power level of the FAP signal component at time T1 with the power level of the FAP signal component at time T3. In some aspects, device D1 may compare the absolute power levels of the FAP signal components between time T1 and time T3.

In other aspects, device D1 may compare relative power levels of the FAP signal components between time T1 and time T3. More specifically, device D1 may compare the power level of the FAP signal components relative to the entire channel power level to determine a relative power level for the FAP signal components. By comparing relative power levels (rather than absolute power levels), the overall channel power may be normalized, for example, to compensate for different receive power levels at time T1 and time T3. For example, even though the person 007 is not obstructing the LOS signal components at time T2 (as depicted in FIG. 4B), it is possible that the overall receive power level may be relatively low (such as less than a threshold). Conversely, even though the person 007 obstructs the LOS signal components at time T3 (as depicted in FIG. 4C), it is possible that the overall power level may be relatively high (such as greater than or equal to the threshold).

In some other implementations, device D1 may compare the shapes of channel impulse responses determined at different times to detect motion in the room 410 (or in other suitable environments). For example, device D1 may compare the shape of the CIR 500 (determined at time T1) with the shape of the CIR 520 (determined at time T2) by determining a correlation between the CIR 500 and the CIR 520. In some aspects, device D1 may use a covariance matrix to determine the correlation between the CIR 500 and the CIR 520. In other aspects, device D1 may perform a sweep to determine a correlation between a number of identified peaks of the CIR 500 and a number of identified peaks of the CIR 520, and may determine whether the identified peaks of the CIR 500 are greater in power than the identified peaks of the CIR 520. In some implementations, if motion is detected, then device D1 may trigger additional motion detection operations to eliminate false positives and/or to update reference information (such as the reference multipath amount). In addition, or in the alternative, device D1 may base a detection of motion on comparisons between FAP power levels and comparisons of multipath amounts.

In some implementations, device D1 may solicit the transmission of one or more wireless signals from device D2, for example, rather than waiting to receive wireless signals transmitted from another device (such as device D2 in the examples of FIGS. 4A-4C). In some aspects, device D1 may initiate an active ranging operation to solicit a response frame from device D2, use the received response frame to estimate channel conditions, and thereafter detect motion based on the estimated channel conditions (such as by comparing the CIR of the response frame with one or more reference CIRs).

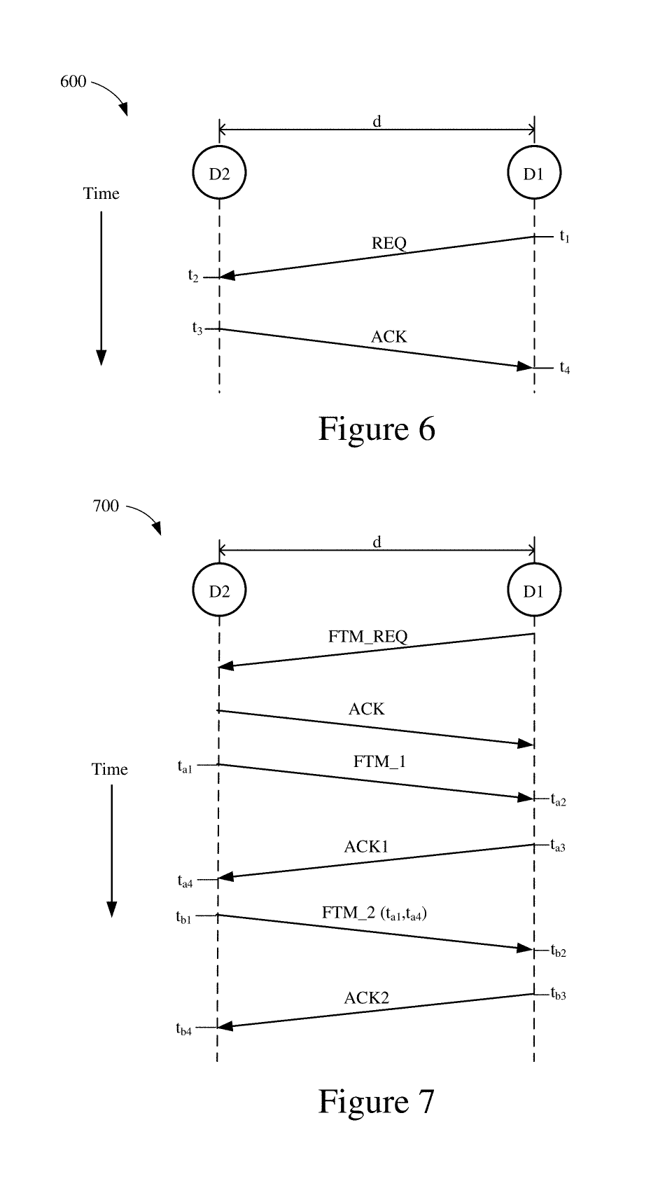

FIG. 6 shows a signal diagram of an example ranging operation 600. The example ranging operation 600, which is performed between the first and second devices D1 and D2, may be used to detect motion in the vicinity of the first device D1. In some implementations, the first device D1 is an IoT device (such as one of IoT devices 130a-130i of FIG. 1 or the wireless device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 600 described below, device D1 is the initiator device (also known as the “requester device”), and the device D2 is the responder device.

At time t₁, device D1 transmits a request (REQ) frame to device D2, and device D2 receives the REQ frame at time t₂. The REQ frame can be any suitable frame that solicits a response frame from device D2 including, for example, a data frame, a probe request, a null data packet (NDP), and so on. At time t₃, device D2 transmits an acknowledgement (ACK) frame to device D1, and device D1 receives the ACK frame at time t₄. The ACK frame can be any frame that is transmitted in response to the REQ frame.

After the exchange of the REQ and ACK frames, device D1 may estimate channel conditions based at least in part on the ACK frame received from device D2. Then, device D1 may detect motion based at least in part on the estimated channel conditions. In some aspects, device D1 may use the estimated channel conditions to determine a channel frequency response (based on the ACK frame), and may then determine a CIR based on the channel frequency response (such as by taking an IFT function of the channel frequency response).

For at least some implementations, device D1 may capture the time of departure (TOD) of the REQ frame, device D2 may capture the time of arrival (TOA) of the REQ frame, device D2 may capture the TOD of the ACK frame, and device D2 may capture the TOA of the ACK frame. Device D2 may inform device D1 of the time values for t₂ and t₃, for example, so that device D1 has timestamp values for t₁, t₂, t₃, and t₄. Thereafter, device D1 may calculate the round trip time (RTT) value of the exchanged FTM_REQ frame and ACK frames as RTT=(t₄−t₃)+(t₂−t₁). The distance (d) between the first device D1 and the second device D2 may be estimated as d=c*RTT/2, where c is the speed of light.

FIG. 7 shows a signal diagram of an example ranging operation 700. The example ranging operation 700, which is performed between first and second devices D1 and D2, may be used to detect motion in the vicinity of the first device D1. In some implementations, the first device D1 is an IoT device (such as one of IoT devices 130a-130i of FIG. 1 or the wireless device 300 of FIG. 3), and the second device D2 is an AP (such as the AP 110 of FIG. 1 or the AP 200 of FIG. 2). For example, device D1 may be a smart television located in the room 410 depicted in FIGS. 4A-4C, and device D2 may be an access point located in the room 410 depicted in FIGS. 4A-4C. In other implementations, each of the first and second devices D1 and D2 may be any suitable wireless device (such as a STA, an AP, or an IoT device). For the ranging operation 700 described below, device D1 is the initiator device (also known as the “requester device”), and the device D2 is the responder device.

Device D1 may request or initiate the ranging operation 700 by transmitting a fine timing measurement (FTM) request (FTM_REQ) frame to device D2. Device D1 may use the FTM_REQ frame to negotiate a number of ranging parameters with device D2. For example, the FTM_REQ frame may specify at least one of a number of FTM bursts, an FTM burst duration, and a number of FTM frame exchanges per burst. In addition, the FTM_REQ frame may also include a request for device D2 to capture timestamps (e.g., TOA information) of frames received by device D2 and to capture timestamps (e.g., TOD information) of frames transmitted from device D2.

Device D2 receives the FTM_REQ frame, and may acknowledge the requested ranging operation by transmitting an acknowledgement (ACK) frame to device D1. The ACK frame may indicate whether device D2 is capable of capturing the requested timestamps. It is noted that the exchange of the FTM_REQ frame and the ACK frame is a handshake process that not only signals an intent to perform a ranging operation but also allows devices D1 and D2 to determine whether each other supports capturing timestamps.

At time tₐ₁, device D2 transmits a first FTM (FTM_1) frame to device D1, and may capture the TOD of the FTM_1 frame as time tₐ₁. Device D1 receives the FTM_1 frame at time tₐ₂, and may capture the TOA of the FTM_1 frame as time tₐ₂. Device D1 responds by transmitting a first FTM acknowledgement (ACK1) frame to device D2 at time tₐ₃, and may capture the TOD of the ACK1 frame as time tₐ₃. Device D2 receives the ACK1 frame at time tₐ₄, and may capture the TOA of the ACK1 frame at time tₐ₄. At time t_{b1}, device D2 transmits to device D1 a second FTM (FTM_2) frame. Device D1 receives the FTM_2 frame at time t_{b2}, and may capture its timestamp as time t_{b2}.

In some implementations, device D1 may estimate channel conditions based on one or more of the FTM frames transmitted from device D2. Device D1 may use the estimated channel conditions to detect motion in its vicinity, for example, as described above with respect to FIGS. 4A-4C and FIGS. 5A-5B. In addition, device D2 may estimate channel conditions based on one or more of the ACK frames transmitted from device D1. Device D2 may use the estimated channel conditions to detect motion in its vicinity, for example, as described above with respect to FIGS. 4A-4C and FIGS. 5A-5B. In some aspects, device D2 may inform device D1 whether motion was detected in the vicinity of device D2 by providing an indication of detected motion in one or more of the FTM frames. In some aspects, device D2 may use a reserved bit in the FTM_1 frame or the FTM_2 frame to indicate whether device D2 detected motion.

In addition, the FTM_2 frame may include the timestamps captured at times tₐ₁ and tₐ₄ (e.g., the TOD of the FTM_1 frame and the TOA of the ACK1 frame). Thus, upon receiving the FTM_2 frame at time t_{b2}, device D1 has timestamp values for times tₐ₁, tₐ₂, tₐ₃, and tₐ₄ that correspond to the TOD of the FTM_1 frame transmitted from device D2, the TOA of the FTM_1 frame at device D1, the TOD of the ACK1 frame transmitted from device D1, and the TOA of the ACK1 frame at device D2, respectively. Thereafter, device D1 may determine a first RTT value as RTT1=(tₐ₄−tₐ₃)+(tₐ₂−tₐ₁). Because the value of RTT1 does not involve estimating SIFS for either device D1 or device D2, the value of RTT1 does not involve errors resulting from uncertainties of SIFS durations. Consequently, the accuracy of the resulting estimate of the distance between devices D1 and D2 is improved (e.g., as compared to the ranging operation 600 of FIG. 6).

Although not shown in FIG. 7 for simplicity, devices D1 and D2 may exchange additional pairs of FTM and ACK frames, for example, where device D2 embeds the timestamps of a given FTM and ACK frame exchange into a subsequent FTM frame transmitted to device D1. In this manner, device D1 may determine an additional number of RTT values.

The accuracy of RTT and channel estimates between wireless devices may be proportional to the frequency bandwidth (the channel width) used for transmitting the FTM and ACK frames. As a result, ranging operations for which the FTM and ACK frames are transmitted using a relatively large frequency bandwidth may be more accurate and may provide better channel estimates than ranging operations for which the FTM and ACK frames are transmitted using a relatively small frequency bandwidth. For example, ranging operations performed using FTM frame exchanges on an 80 MHz-wide channel provide more accurate channel estimates than ranging operations performed using FTM frame exchanges on a 40 MHz-wide channel, which in turn provide more accurate channel estimates than ranging operations performed using FTM frame exchanges on a 20 MHz-wide channel.

Because Wi-Fi ranging operations may be performed using frames transmitted as orthogonal frequency-division multiplexing (OFDM) symbols, the accuracy of RTT estimates may be proportional to the number of tones (such as the number of OFDM sub-carriers) used to transmit the ranging frames. For example, while a legacy (such as non-HT) frame may be transmitted on a 20 MHz-wide channel using 52 tones, an HT frame or VHT frame may be transmitted on a 20 MHz-wide channel using 56 tones, and an HE frame may be transmitted on a 20 MHz-wide channel using 242 tones. Thus, for a given frequency bandwidth or channel width, FTM ranging operations performed using HE frames provide more accurate channel estimates than FTM ranging operations performed using VHT frames, FTM ranging operations performed using HE frames provide more accurate channel estimates than FTM ranging operations performed using VHT frames, and FTM ranging operations performed using HE frames provide more accurate channel estimates than FTM ranging operations performed using VHT frames.

Thus, in some implementations, the ACK frames of the example ranging operation 700 may be one of a high-throughput (HT) frame, a very high-throughput (VHT) frame, or a high-efficiency (HE) frame, for example, so that device D1 can estimate channel conditions over a wider bandwidth as compared with legacy frames (such as 20 MHz-wide frames exchanged in the example ranging operation 600 of FIG. 6). Similarly, in some implementations, the FTM frames of the example ranging operation 700 may be one of a high-throughput (HT) frame, a very high-throughput (VHT) frame, or a high-efficiency (HE) frame, for example, so that device D2 can estimate channel conditions over a wider bandwidth as compared with legacy frames (such as 20 MHz-wide frames exchanged in the example ranging operation 600 of FIG. 6).

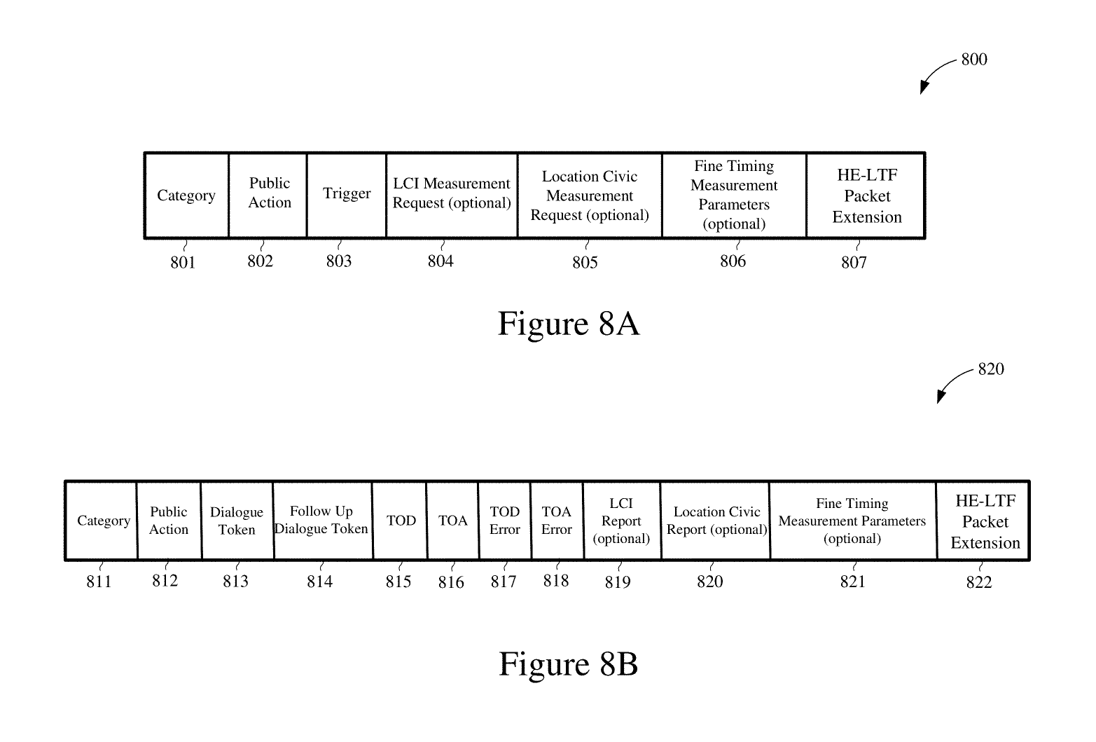

FIG. 8A shows an example fine timing measurement request (FTM_REQ) frame 800. The FTM_REQ frame 800 may be one implementation of the FTM_REQ frame depicted in the ranging operation 700 of FIG. 7. The FTM_REQ frame 800 may include a category field 801, a public action field 802, a trigger field 803, an optional location civic information (LCI) measurement request field 804, an optional location civic measurement request field 805, and an optional FTM parameters field 806. The fields 801-806 of the FTM_REQ frame 800 are well-known, and therefore are not discussed in detail herein. In some aspects, the FTM_REQ frame 800 may include a packet extension 807. The packet extension 807 can contain one or more sounding sequences such as, for example, HE-LTFs.

FIG. 8B depicts an example FTM measurement frame 810. The FTM measurement frame 810 may be one implementation of the FTM_1 and FTM_2 frames depicted in the example ranging operation of FIG. 7. The FTM measurement frame 810 may include a category field 811, a public action field 812, a dialogue token field 813, a follow up dialog token field 814, a TOD field 815, a TOA field 816, a TOD error field 817, a TOA error field 818, an optional LCI report field 818, an optional location civic report field 820, and an optional FTM parameters field 821. The fields 811-821 of the FTM frame 810 are well-known, and therefore are not discussed in detail herein.

In some aspects, the FTM measurement frame 810 may include a packet extension 822. The packet extension 822 may contain one or more sounding sequences such as, for example, HE-LTFs. As described above, a number of reserved bits in the TOD error field 817 and/or the TOA error field 818 of the FTM measurement frame 810 may be used to store an antenna mask.

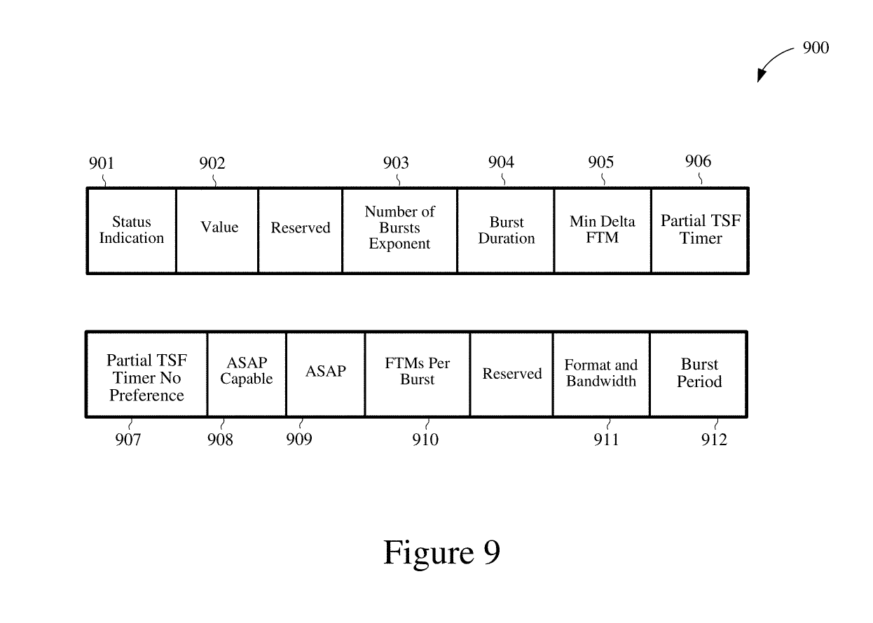

FIG. 9 shows an example FTM parameters field 900. The FTM parameters field 900 is shown to include a status indication field 901 that may be used to indicate the responding device's (such as device D2 of FIGS. 4A-4C) response to the FTM_REQ frame. The number of bursts exponent field 903 may indicate a number of FTM bursts to be included in the ranging operation of FIG. 7. The burst duration field 904 may indicate a duration of each FTM burst in the ranging operation of FIG. 7. The FTMs per burst field 910 may indicate how many FTM frames are exchanged during each burst in the ranging operation of FIG. 7. The burst period field 912 may indicate a frequency (such as how often) of the FTM bursts in the ranging operation of FIG. 7.

Ideally, the motion detection and ranging operations disclosed herein are performed in an environment having low levels of interference and noise. Unwanted interference and noise may be generated by devices D1-D2, and by other wireless devices in their vicinity. In many instances, the source of interference and noise may not be known or may not be effectively controlled (or both). For example, in implementations for which device D2 is a smart television, the user may turn the smart television on or off while device D1 is estimating channel conditions or determining the CIR of signals transmitted from the smart television, which in turn can generate unwanted noise and interference.

The multipath amounts measured by device D1 at times T1 and T2 may be affected by such unwanted noise and interference, which may lead to incorrect indications of motion in the room 410. Further, if the level of noise or interference in the room 410 is greater at time T2 than the level of noise or interference in the room 410 at time T1, then the measured multipath amount at time T2 may be greater than the measured multipath amount at time T1 irrespective of a presence of motion in the room 410 at time T2, which may lead to incorrect indications of motion in the room 410. As a result, unknown or unpredictable variations in noise or interference in the room 410 may affect measured multipath amounts in a manner that reduces the accuracy with which motion can be detected based on differences in channel conditions or multipath amounts.

More specifically, although the motion of an object in the room 410 may result in differences between measured multipath amounts at different times (such as at times T1, T2 and T3), these differences in multipath amounts may be relatively small compared to multipath variations caused by noise or interference. For example, if the room 410 is a rich multipath environment (such as having relatively high amounts of multipath amounts without any motion in the room 410), then it may be difficult to detect motion of an object in the room 410, particularly when the object is moving relatively close to the transmitting device (device D2) or the receiving device (device D1). For another example, if the transmitting device (device D2) and the receiving device (device D1) are in close proximity of each other (e.g. placed close to each other in room 410), then the LOS signal components of the wireless signal 401 may be significantly stronger than the NLOS signal components of the wireless signal 401, which may cause the reference multipath amount to be dominated by the LOS signal components such that differences in multipath amounts of the NLOS signal components resulting from motion in the room 410 may not be detected.

In accordance with various aspects of this disclosure, the accuracy with which motion can be detected using wireless signals may be improved by using differences in power levels of the channel impulse responses to detect motion (rather than using differences in multipath amounts), particularly in rich multipath environments or when the transmitting device and the receiving device are in close proximity to each other. In some implementations, data points in the channel impulse responses of a wireless signal transmitted from device D2 to device D1 may be used to determine a CIR power profile of the wireless signal. The determined CIR power profile may be compared with one or more reference CIR power profiles to detect a presence of motion, even when the room 410 produces a rich multipath profile and/or when the devices D1 and D2 are placed in close proximity of each other. In some aspects, a presence or absence of motion may be determined using only CIR power profiles. In other aspects, the presence or absence of motion may be determined using CIR power profiles and measured multipath amounts.

In some implementations, differences in multipath amounts may be used to detect motion when the multipath profile of the room 410 is less than a threshold amount or when a distance between the devices D1 and D2 is greater than a threshold distance, and the CIR power profiles may be used to detect motion when the multipath profile of the room 410 is greater than or equal to the threshold amount or when the distance between the devices D1 and D2 is not greater than the threshold distance. In some aspects, an environment may be determined to have a rich multipath profile if the amount of multipath in the environment is greater than or equal to the threshold amount, and may be determined to not have a rich multipath profile if the amount of multipath in the environment is less than the threshold amount.

The proximity of devices D1 and D2 may be determined from signals transmitted by the devices. In some implementations, the distance between a transmitting device and a receiving device may be determined using received signal strength indicator (RSSI) values of signals exchanged between the devices. In some aspects, a relatively high RSSI value may indicate that the devices D1 and D2 are in close proximity with each other, while a relatively low RSSI value may indicate that the devices D1 and D2 are not in close proximity with each other.

In some implementations, a device may receive a number of signals or packets, determine a number of reference CIRs based on the received signals or packets, and then determine a number of reference CIR power levels based on the reference CIRs. In some aspects, the reference CIR power levels may be aligned in time with each other to determine a reference CIR power profile. An example operation for determining a reference CIR power profile may include the following steps:
Capture a temporary reference CIR for each of P packets to determine a number of reference CIRs CIR₁ to CIR_{P}. Each CIRᵢ may include N samples, CIRᵢ(1:N), i=1, 2, . . . , P, and each sample is a complex number with in-phase (I) and quadrature (Q) components.
Convert each temporary reference CIR to a temporary reference CIR power level by computing I²+Q² to convert CIRᵢ to CIRᵢ^{power}, i=1, 2, . . . P. Each CIRᵢ^{power} may include N samples, CIRᵢ^{power}(1:N), and each sample is a non-negative real number.
Align the reference CIR power levels CIR₁^{power} to CIR_{P}^{power} in time to determine a number of time-aligned CIR power levels CIRᵢ^{powerAlign} to CIRᵢ^{powerAlign}.
   In accordance with various aspects of this disclosure, two example algorithms are disclosed that may be used to align CIR₁^{power} to CIR_{P}^{power} in time with each other. However, it will be apparent to one skilled in the art that other algorithms may be used to align CIR₁^{power} to CIR_{P}^{power} in time with each other.

The first algorithm, hereinafter denoted as “Algorithm 1,” is based on aligning the first peak position in the CIR to occur at tap 0 in the profile of the temporary reference CIR power. In some implementations, Algorithm 1 may include the following steps or operations:
For CIRᵢ^{power}, detect the first strongest tap, say CIRᵢ^{power}(j), for which CIRᵢ^{power}(j)≥CIRᵢ^{power}(k) for any k>j and CIRᵢ^{power}(j)>CIRᵢ^{power}(p) for any p<j.
Define a first peak detection threshold Th as Th=α×CIRᵢ^{power}(j). For example, α=0.1.
Detect the first tap that is stronger than Th, say CIRᵢ^{power}(m), for which CIRᵢ^{power}(m)≥Th and CIRᵢ^{power}(n)<Th for any n<m.
Search from CIRᵢ^{power}(m) to CIRᵢ^{power}(j) to find the first peak CIRᵢ^{power}(q), for which CIRᵢ^{power}(q)≥CIRᵢ^{power}(q−1) and CIRᵢ^{power}(q)≥CIRᵢ^{power}(q+1).
Cyclically shift CIRᵢ^{power} to make q the first tap such that CIRᵢ^{powerAlign}=[CIRᵢ^{power}(q:N) CIRᵢ^{power}(1:q−1)].
Repeat the above steps for each of CIR₁^{power} to CIR_{P}^{power} to determine CIR₁^{powerAlign} to CIR_{P}^{powerAlign}.

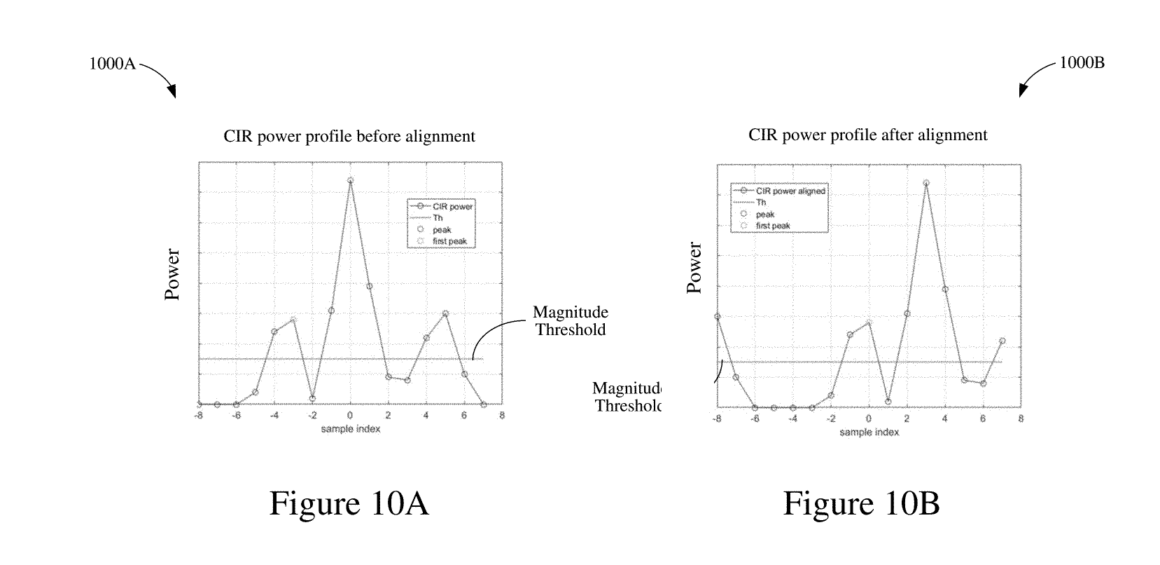

An example operation using Algorithm 1 is described with respect to the example plots shown in FIGS. 10A-10B, where FIG. 10A shows an example CIR power plot 1000A before alignment, and FIG. 10B shows an example CIR power plot 1000B after alignment. In some implementations, Algorithm 1 may include the following steps or operations:
Detect the tap corresponding to the strongest CIR power in the temporary reference CIR power plot 1000A, which is identified as tap 0 in FIG. 10A.
Detect the first tap in the temporary reference CIR power plot 1000A that is stronger than a magnitude threshold, which is tap −4 in FIG. 10A.
Search from tap −4 to tap 0 in the temporary reference CIR power plot 1000A to find the first peak, which is tap −3 because the CIR power at tap −3 is greater than the CIR power level at taps −4 or −2.
Cyclically shift the temporary reference CIR power plot 1000A so that the tap −3 is shifted in time to occur at tap 0, for example, as shown in FIG. 10B.

The second algorithm, hereinafter denoted as “Algorithm 2,” is based on maximizing the cross-correlation between the data points or taps of the temporary reference CIR power plot. In some implementations, Algorithm 2 may include the following steps or operations:
Select a first temporary reference CIR power CIR₁^{power} as the reference CIR power.
For all other temporary reference CIR powers CIRᵢ^{power}, i=2, 3, . . . , P, perform cross-correlation between CIR₁^{power} and CIRᵢ^{power} to determine a cross-correlation result Corrᵢ(1:N), where

Corrᵢ(t)=Σₛ₌₁^{N+1-t}CIR₁^{power}(s)×CIRᵢ^{power}(s+t−1)+Σ_{s=N+2-t}^{N}CIR₁^{power}(s)×CIRᵢ^{power}(s+t−1−N),t=1, . . . ,N.
Detect the first peak in the cross-correlation result Corrᵢ(1:N), say j, for which Corrᵢ(j)≥Corrᵢ(k) for any k>j and Corrᵢ(j)>Corrᵢ(m) for any m<j.
Cyclically shift CIRᵢ^{power} to make j the first tap such that CIRᵢ^{powerAlign}=[CIRᵢ^{power}(j:N) CIRᵢ^{power}(1:j−1)].
Repeat for each of CIR powers CIR₂^{power} to CIR_{P}^{power} to determine CIR₂^{powerAlign} to CIR_{P}^{powerAlign}, CIR₁^{powerAlign}=CIR₁^{power}.

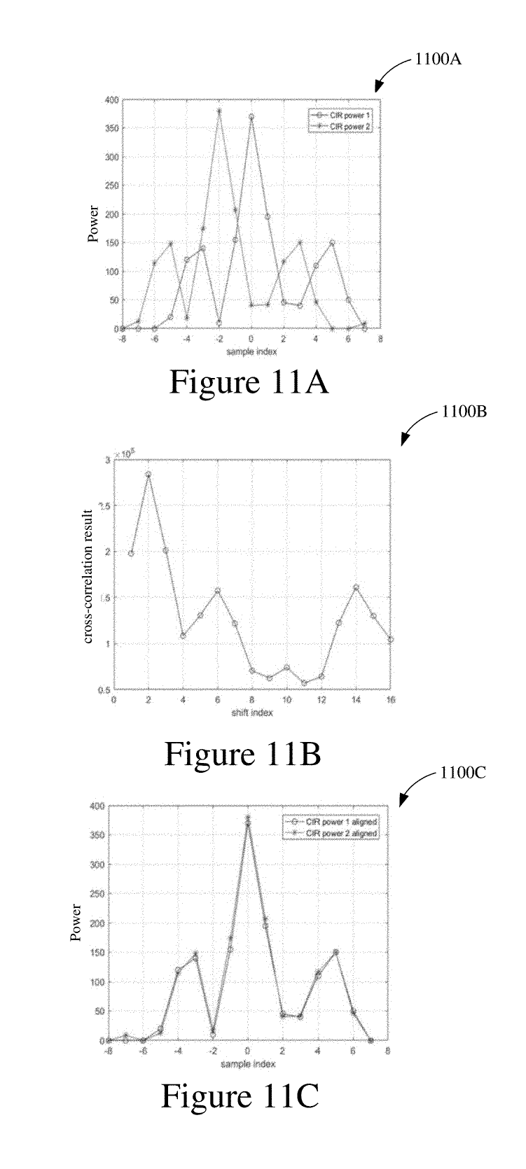

An example operation using Algorithm 2 is described with respect to the example plots shown in FIGS. 11A-11C, where FIG. 11A is a plot 1100A depicting two example CIR power profiles before alignment in time with each other, FIG. 11B is a plot 1100B of an example cross-correlation result, and FIG. 11C is a plot 1100C depicting two example CIR power profiles after alignment in time with each other. In some implementations, Algorithm 2 may include the following steps or operations:
Receive a first packet, determine a first temporary reference CIR power and select it as the reference CIR power (which is the first temporary reference CIR power in the plot 1100A of FIG. 11A).
Receive a second packet and determine a second temporary reference CIR power (which is the second temporary reference CIR power in the plot 1100A of FIG. 11A). The second temporary reference CIR power may not align with the first temporary reference CIR power, as shown in the plot 1100A of FIG. 11A.
Determine the cross-correlation between the first temporary reference CIR power and the second temporary reference CIR power, as shown in the plot 1100B of FIG. 11B.
Determine the peak in the correlation result, which is at tap position 2 in the plot 1100B of FIG. 11B.
Cyclically shift the second temporary reference CIR power by 2 tap samples to the right so that the second temporary reference CIR power aligns with the first temporary reference CIR power, as shown in the plot 1100C of FIG. 11C.

After aligning the temporary reference CIR power using Algorithm 1 or Algorithm 2 (or any other suitable algorithm) the device may determine the reference CIR power CIR_{ref}^{power}(1:N) by computing the average of CIR₁^{powerAlign}(1:N) to CIR_{P}^{powerAlign}(1:N) based on the expression:

$${CIR}_{ref}^{power} ( i ) = \frac{1}{P} {\sum }_{k = 1}^{P} {CIR}_{k}^{power Align} ( i )$$

The reference CIR power may be stored in a wireless device and thereafter used by the wireless device for motion detection operations. In addition, or in the alternative, the reference CIR power may be used to detect changes in the surrounding environment. In some implementations, the reference CIR power may be used to detect the presence of a new object in the vicinity of the wireless device, even if the new object is not moving, as long as the reference CIR power is determined when the new object is not present.

In some implementations, detecting whether a motion of an object is occurring in the room may depend on a correlation degree between a received signal's CIR power and the reference CIR power. The correlation degree may be represented by a real number ranging from 0 to 1 (such as between 0% and 100%). In some aspects, a correlation degree of 0 (0%) may indicate that the received signal's CIR power is independent of the reference CIR power (such as no correlation), and a correlation degree of 1 (100%) may indicate that the received signal's CIR power is identical to the reference CIR power.

Since the reference CIR power is determined when there is no expectation of movement or motion in the room, the CIR power of a received signal may be very similar (or identical) to the reference CIR power when no motion is present in the room. In such a case, the determined correlation degree may be at the high end of the correlation degree range (such as between approximately 90% to 100%). If there is motion in the room, or if there is a change in the room environment (such as resulting from the presence of a human or an object), the correlation degree between the received signal's CIR power and the reference CIR power may be at a low end of the correlation range.

In some implementations, the determined correlation degree may be compared to a correlation degree threshold for determining whether there is a presence of motion in the room. In some aspects, if the determined correlation degree is greater than the correlation degree threshold (such as indicating a greater correlation to the reference CIR power), then a device may indicate that there is no motion in the room or environment. Conversely, if the determined correlation degree is not greater than the correlation degree threshold (such as indicating a lesser correlation to the reference CIR power), then the device may indicate that there is at least some motion in the room or environment. The correlation degree threshold may be preprogrammed, or determined by the device during operation and other times.

The correlation degree threshold may be determined at any time (and on demand) by the receiving device. In some implementations, the following steps or operations may be used to determine the optimal correlation degree threshold:
From the measurements collected to determine the reference CIR power, the temporary reference CIR power CIR₁^{powerAlign} to CIRᵢ^{powerAlign} are known. The reference CIR power CIR_{ref}^{power} is also known. The algorithm for determining the optimal correlation degree threshold may involve computing the cross-correlation between each CIRᵢ^{powerAlign} and CIR_{ref}^{power}, i=1, 2, . . . P to determine a number P of correlation degrees CD₁ to CD_{P}. The following equation may be used to compute the correlation of CIRᵢ^{powerAlign} and CIRᵢ^{power}:

$${CD}_{i} = \frac{{\sum }_{k = 1}^{N} {CIR}_{i}^{power Align} ( k ) \times {CIR}_{ref}^{power} ( k )}{\sqrt{{\sum }_{k = 1}^{N} {{CIR}_{i}^{power Align} ( k )}^{2}} \times \sqrt{{\sum }_{k = 1}^{N} {{CIR}_{ref}^{power} ( k )}^{2}}}$$

Next, the values of CD₁ to CD_{P} may be used to determine the correlation degree threshold CDₜₕ. The optimum correlation degree threshold CDₜₕ may be the minimum of CD₁ to CD_{P}. Alternatively, the optimum correlation degree threshold CDₜₕ may be the 2^{nd} minimum of CD₁ to CD_{P}. In other aspects, the optimum correlation degree threshold CDₜₕ may be the mean value of CD₁ to CD_{P}. In some other aspects, the optimum correlation degree threshold CDₜₕ may be the median of CD₁ to CD_{P}. The optimum correlation degree threshold CDₜₕ may be based on any selection function involving one or more of the CD₁ to CD_{P}, and the selection function may be predetermined by experimentation and/or determined while the device is in operation in the room, as long as the selection function produces a reliable motion detection operation.
The selected CDₜₕ may also be adjusted by CD_{adjust} to determine the final correlation degree threshold CD_{Th}^{final}=CDₜₕ−CD_{adjust}, for example, where CD_{adjust} is a factor that may improve reliability of the motion detection operation.

Since the reference CIR power is determined when there is no expectation of movement or motion in the room, the correlation degree between each temporary reference CIR power and the reference CIR power should be very high, which in turn may result in a high value for CDₜₕ. If the value of CDₜₕ is relatively low (such as CDₜₕ<CD_{low}), then the reference CIR power may not be reliable, for example, either because there is motion in the room when the reference CIR power is determined or because of certain multipath patterns. To compensate for the relatively low value of CDₜₕ, the reference CIR power may be determined again at another time when there is no motion present in the room, the user may change the location of one of the devices (such as either device D1 or device D2) to change the multipath pattern, or a combination thereof.

The correlation degree threshold may be determined at any time (and on demand) by the receiving device. Furthermore, a correlation degree threshold may be preprogrammed in the receiving device based on laboratory experimentation and analysis. In such a case, the preprogrammed correlation degree threshold may be used as an initial value for optimizing the correlation degree threshold, which may then be used in motion detection operations. The following algorithm may be used to determine the optimal correlation degree threshold that could be used in the process of motion detection:
If a correlation degree threshold is preprogrammed by software in the device, the software can determine the optimal correlation degree threshold based on the measured received signal strength indicator (RSSI) value and the multipath amount.
RSSI values may be reported for every packet. A RSSI value indicates that the transmitting device and the receiving device are in close proximity to each other.
The CIR correlation degree between the reference CIR power and the received signal's CIR power is typically greater for high RSSI values than for low RSSI values. As such, when an RSSI value is relatively high, a relatively high value may be selected for the correlation degree threshold.
If the RSSI value is low (such as indicating that the transmitting device and the receiving device are not in close proximity), then a relatively low value may be selected for the correlation degree threshold.

In some implementations, the device may be preprogrammed with a particular mapping between RSSI values and various levels of the correlation degree threshold. For example, if RSSI>RSSIₜₕ^{high}, then a relatively high correlation degree threshold=Th_{high} may be selected. If RSSI<RSSIₜₕ^{low}, then a relatively low correlation degree threshold=Th_{low} may be selected. Otherwise, a default midlevel correlation degree threshold=Th_{mid} may be selected.

In some implementations, the multipath amount of the received signal may be used in the selection of the correlation degree threshold. A high level of multipath amount may indicate that the signal propagation environment is a rich multipath environment. In a rich multipath environment, the correlation degree between the reference CIR and the received signal's CIR may be relatively low, and thus a relatively low correlation degree threshold level may be selected. Conversely, if the multipath amount is relatively low, then the correlation degree between the reference CIR power and the received signal's CIR power may be relatively high, and thus a relatively high correlation degree threshold may be selected.

In some aspects, the device may be preprogrammed with a particular mapping between the multipath amount levels and various levels of the correlation degree threshold, and the selection of the correlation degree threshold may be made in accordance with such a mapping. For example, if the multipath amount>MAₜₕ^{high}, then the selection for the correlation degree threshold may equal Th′_{low}. If the multipath amount<MAₜₕ^{low}, then the selection for the correlation degree threshold may equal Th′_{high}. Otherwise, a default midlevel correlation degree threshold equal to Th′_{mid} may be selected. In some implementations, the mapping of RSSI values and multipath amounts to various correlation degree thresholds may include any mapping between a suitable number of RSSI levels, multipath amount levels and correlation degree threshold levels, although only low/mid/high levels are included in the disclosure.

In other implementations, detecting a presence of motion in the room may be based on a correlation degree between a first received signal's CIR power and a second received signal's CIR power, for example, without using a reference CIR power. The correlation degree may be represented by a real number ranging from 0 to 1 (such as between 0% and 100%). A correlation degree of 0 (0%) may indicate that the first received signal's CIR power is independent of the second received signal's CIR power (such as no correlation). A correlation degree of 1 (100%) may indicate that the first received signal's CIR power is identical to the second received signal's CIR power. If there is no motion present in the room, the first received signal's CIR power may be very similar to the second received signal's CIR power. In such a case, the determined correlation degree may be relatively high (such as between 90% and 100%).

If there is motion in the room, the correlation degree between the first received signal's CIR power and the second received signal's CIR power may be relatively low. The value determined for the correlation degree may be compared to a correlation degree threshold for determining whether there is a presence of motion in the room. In one example, if the correlation degree is greater than the correlation degree threshold, then the receiving device may indicate that there is no motion in the room or environment. Conversely, if the correlation degree is not greater than the correlation degree threshold, then the receiving device may indicate that there is at least some motion in the room or environment. The correlation degree threshold may be preprogrammed, or may be determined by the receiving device during operation (or at other times).

In some implementations, motion may be detected based on either comparing differences in multipath amounts or on cross-correlating points in CIR power profiles. In other implementations, motion may be detected based on a combination of comparing differences in multipath amounts and cross-correlating points in CIR power profiles. In some aspects, a weighting factor may be assigned to improve the reliability of motion detection operations. More specifically, the receiving device may perform both motion detection operations (such as using CIR power profiles and multipath amounts) to detect a presence (or absence of motion), and may assign a weighting factor to the results of the motion detection operations. In this manner, two results from the motion detection operations may be used to determine a presence or absence of motion. In some aspects, a weighting factor may be applied to the result of each motion detection operation and then combined to produce a final result to indicate a presence or absence of motion. The weighting factor may be a value W between 0 to 1 selected based on the measured RSSI and multipath amount.

When the transmitting device and the receiving device are in close proximity with each other, motion detection operations based on the CIR power profiles may be more accurate than motion detection operations based on the multipath amounts. As such, a high weighting W_{high} (a value closer to 1) may be used to factor motion detection results based on CIR power profiles, and a lower weighting W_{low} (a value closer to 0) may be used to factor motion detection results based on multipath amounts. The combined motion detection result may be represented as: MD_{final}=W_{high}×MD_{CIR}+W_{low}×MD_{MA}. If MD_{final}>Th_{final}, then motion is detected.

When the transmitting device and the receiving device are not in close proximity with each other, motion detection operations based on the CIR power profiles may be less accurate than motion detection operations based on the multipath amounts. In such a case, a low weighting W_{low} (closer to 0) may be used to factor the motion detection results based on the CIR power profiles, and a high weighting W_{high} (closer to 1) may be used to factor the motion detection results based on the multipath amounts. The combined motion detection result may be represented as: MD_{final}=W_{low}×MD_{CIR}+W_{high}×MD_{MA}. If MD_{final}>Th_{final}, then motion is detected.

When the environment is multipath rich, motion detection operations based on the CIR power profiles may be more accurate than motion detection operations based on the multipath amounts. As such, a higher weighting W_{high} (i.e. closer to 1) may be used to factor the motion detection results based on the CIR power profile, and a lower weighting W_{low}(closer to 0) may be used to factor the motion detection results based on the multipath amounts. The combined motion detection result may be represented as: MD_{final}=W_{high}×MD_{CIR}+W_{low}×MD_{MA}. If MD_{final}>Th_{final}, then motion is detected.

When the environment is mainly clear of objects and walls (such as when the environment is not multipath rich), motion detection operations based on the CIR power profiles may be less accurate than motion detection operations based on the multipath amounts. As such, a lower weighting W_{low} (closer to 0) may be used to factor the motion detection results based on the CIR power profiles, and a higher weighting W_{high} (closer to 1) may be used to factor the motion detection results based on the multipath amounts. The combined motion detection result may be represented as: MD_{final}=W_{low}×MD_{CIR}+W_{high}×MD_{MA}. If MD_{final}>Th_{final}, then motion is detected. In some implementations, any RSSI value higher than a high threshold (such as RSSI>RSSIₜₕ^{high}) may be considered to be a high RSSI, and any RSSI value less than a low threshold (such as RSSI<RSSIₜₕ^{low}) may be considered to be a low RSSI. A mapping between several levels of RSSI and the possible weighting factors may be used. Similarly, any multipath amount higher than a high threshold (such as multipath amount>MAₜₕ^{high}) may be considered to be a high multipath amount, and any multipath amount less than a low threshold (such as multipath amount<MAₜₕ^{low}) may be considered to be a low multipath amount. A mapping between several levels of multipath amount and the possible weighting factors may be used.

An example mapping between different levels of RSSI/multipath amount and the corresponding weighting factors is summarized below in Table 1.

TABLE 1

| | | | Weighting |
|---|---|---|---|
| | | Weighting | factor |
| | | factor | of |
| | | of CIR | multipath |
| RSSI | Multipath amount | correlation | amount |
| >−66 dBm | >200 ns | 0.9 | 0.1 |
| >−66 dBm | Between 50 ns and 200 ns | 0.7 | 0.3 |
| >−66 dBm | <50 ns | 0.5 | 0.5 |
| Between −86 dBm | >200 ns | 0.7 | 0.3 |
| and −66 dBm | | | |
| Between −86 dBm | Between 50 ns and 200 ns | 0.5 | 0.5 |
| and −66 dBm | | | |
| Between −86 dBm | <50 ns | 0.3 | 0.7 |
| and −66 dBm | | | |
| <−86 dBm | >200 ns | 0.5 | 0.5 |
| <−86 dBm | Between 50 ns and 200 ns | 0.3 | 0.7 |
| <−86 dBm | <50 ns | 0.1 | 0.9 |

In some implementations, motion detection operations disclosed herein may involve coarse motion detection and fine motion detection operations. For coarse motion detection operations, data collection for motion detection may occur periodically with a long period of time passing between the data collection times (such as data collected every T1 seconds). For each data collection time, a number of data packets (such as N1 packets) may be transmitted and received. If the coarse motion detection operation does not indicate motion, then the coarse motion detection operation may continue at the same or similar periodicity. If the coarse motion detection operation indicates motion, then the fine motion detection operation may be used.

The fine motion detection operation may occur periodically with a shorter period of time passing between the data collection times (such as data collected every T2 seconds, where T2<T1). For each data collection time in the fine motion detection operation, a number of data packets (such as N2 packets) may be transmitted and received, and the operation may be repeated a number of time (such as K times). If motion is detected more than a threshold number Q of K times, then the device may indicate a presence of motion. If motion is detected fewer than the threshold number Q of times, then the coarse motion detection operations may be used again.

In some implementations, the coarse motion detection operation may include the following steps:
Step#1. Run N1 packets each time and get N1 CIR. Compute the power of the CIR and to determine N1 CIR powers. Align the N1 CIR powers to determine N1 aligned CIR powers.
Step#2. Determine the correlation degree between the reference CIR power CIR_{ref}^{power} and each aligned CIR power to determine N1 correlation degrees.
Step#3. Determine the minimum of the N1 correlation degrees.
Step#4. If the minimum is less than the correlation degree threshold CDₜₕ^{final}, then coarse motion is detected and the fine motion detection operation may be used. Otherwise, repeat step #1 to #3.

In some implementations, the fine motion detection operation may include the following steps:
Step#1. Run N2 packets each time and determine N2 CIRs. Compute the power of the CIR and to determine N2 CIR powers. Align the N2 CIR powers to determine N2 aligned CIR powers.
Step#2. Determine the correlation degree between the reference CIR power CIR power and each aligned CIR power to determine N2 correlation degrees.
Step#3. Determine the minimum of the N2 correlation degrees.
Step#4. Repeat step #1 to #3 for K times and determine K min.
Step#5. If more than Q out of the K min are less than the correlation degree threshold CDₜₕ^{final}, motion is detected. Otherwise, return to the coarse motion detection operation.

At any time, if a packet shows a correlation degree<Th_{exception}, then motion may be indicated. The value of Th_{exception} may be chosen to be very low to ensure the packet is very different from the reference caused by motion.

Using the reference CIR power may not be necessary under certain conditions. The correlation between a first aligned CIR power and a second aligned CIR power may be used to determine a first correlation degree, and the correlation between the second aligned CIR power and a third aligned CIR power may be used to determine a second correlation degree. With multiple correlation degrees determined, the same coarse motion detection, fine motion detection and exception operations can be used to detect motion.

In some implementations, up-sampling may be applied to a CIR before determining a degree of correlation. Any suitable up-sampling technique can be used to up-sample the CIR to achieve a finer resolution. Using an up-sampled CIR to determine a correlation degree may improve the accuracy of motion detection operations disclosed herein.

Cross-correlating data points in CIR power profiles may be computationally complex and may consume a significant amount of memory, for example, because determining the CIR power involves calculating values of I²+Q² (which not only requires multipliers but also increases word length). To reduce the computational complexity and memory space associated with motion detection operations, CIR magnitudes may be used to detect a presence or absence of motion (rather than CIR power levels) without sacrificing performance or accuracy and without using a reference CIR.

In some implementations, a first CIR magnitude algorithm may include the following steps or operations:
Determine a first channel impulse response (CIR₁) for the first frame, and determine a second channel impulse response (CIR₂) for the second frame. Each channel impulse response includes a number N of samples and may be expressed as CIRᵢ(1:N), where i=[1:2]. In some aspects, each of the N samples is a complex number with in-phase (I) and quadrature (Q) components.
Determine the magnitude \sqrt{I²+Q²} of each channel impulse response CIRᵢ to generate a corresponding channel impulse response magnitude profile CIRᵢ^{mag}, where i=[1:2]. Each of the CIR magnitude profiles CIRᵢ^{mag} includes a number N of samples and may be expressed as CIRᵢ^{mag}(1:N). In some aspects, each of the N samples is a non-negative real number. In other implementations, computational complexity may be reduced by approximating the magnitudes of the channel impulse responses, for example, such that the magnitude≈max(abs(I), abs(Q))+min(abs(I), abs(Q))/4.
Perform a cross-correlation between the CIR magnitude profile of the first frame CIR₁^{mag} and the CIR magnitude profile of the second frame CIR₂^{mag} to determine a cross-correlation result Corr (1:N). In some aspects, the cross-correlation result Corr (t) may be determined as:

$$Corr ( t ) = \frac{\begin{matrix}{\sum }_{s = 1}^{N + 1 - t} {CIR}_{1}^{mag} ( s ) \times {CIR}_{2}^{mag} ( s + t - 1 ) + \\ {\sum }_{s = N + 2 - t}^{N} {CIR}_{1}^{mag} ( s ) \times {CIR}_{2}^{mag} ( s + t - 1 - N )\end{matrix}}{\sqrt{{\sum }_{k = 1}^{N} {{CIR}_{i}^{mag} ( k )}^{2}} \times \sqrt{{\sum }_{k = 1}^{N} {{CIR}_{ref}^{mag} ( k )}^{2}}} , \\ t = 1 , … , N$$

Detect the first peak in Corrᵢ(1:N), say j, for which Corrᵢ(j)≥Corrᵢ(k) for any k>j and Corrᵢ(j)>Corrᵢ(m) for any m<j.
Compare the peak correlation (Corrₚₑₐₖ) with the correlation degree threshold (Th). If the peak correlation is less than the correlation degree threshold (such as Corrₚₑₐₖ<Th), then the channel conditions have changed due to motion, and thus a presence of motion may be indicated. Conversely, if the peak correlation is not less than the correlation degree threshold, then an absence of motion may be indicated.

The first CIR magnitude algorithm requires cross-correlation for N times to detect the peak cross correlation level. To reduce computational complexity, a second CIR magnitude algorithm may be used to estimate the location of the peak cross correlation, and thereafter use a limited number M of samples before and after the estimated location to detect the peak cross correlation. An example operation to detect motion using the second CIR magnitude algorithm, where M=N/8, is as follows:
For CIRᵢ^{mag}, detect the strongest tap, say CIRᵢ^{mag} (j), for which CIRᵢ^{mag} (j)≥CIRᵢ^{mag}(k) for any k between 1 to N and k≠j.
Define a first peak detection threshold Th as Th=α×CIRᵢ^{mag}(j). For example, α=0.3.
Detect the first tap that is stronger than Th, say CIRᵢ^{mag} (m), for which CIRᵢ^{mag}(m)≥Th and CIRᵢ^{mag}(n)<Th for any n<m.
Search from CIRᵢ^{mag}(m) to CIRᵢ^{mag}(j) to find the first peak CIRᵢ^{mag}(q), for which CIRᵢ^{mag}(q)≥CIRᵢ^{mag}(q−1) and CIRᵢ^{mag}(q)≥CIRᵢ^{mag}(q+1).
Cyclically shift CIRᵢ^{mag} until q becomes the first tap such that CIRᵢ^{magAlign}=[CIRᵢ^{mag}(q:N) CIRᵢ^{mag}(1:q−1)].
Repeat steps 1 to 5 for CIR₁^{mag} and CIR₂^{mag} to determine CIR₁^{magAlign} and CIR₂^{magAlign}.
Perform cross-correlation between CIR₁^{magAlign} and CIR₂^{magAlign} to determine the cross-correlation result Corr (−M:M), where:

$$\begin{matrix}Corr ( t ) = \frac{\begin{matrix}{\sum }_{s = 1}^{N + 1 - t} {CIR}_{1}^{mag Align} ( s ) \times {CIR}_{2}^{mag Align} ( s + t - 1 ) + \\ {\sum }_{s = N + 2 - t}^{N} {CIR}_{1}^{mag Align} ( s ) \times {CIR}_{2}^{mag Align} ( s + t - 1 - N )\end{matrix}}{\sqrt{{\sum }_{k = 1}^{N} {{CIR}_{i}^{mag Align} ( k )}^{2}} \times \sqrt{{\sum }_{k = 1}^{N} {{CIR}_{2}^{mag Align} ( k )}^{2}}} , t \\ = - M , … , M , M < \frac{N}{2} , e . g . , M = \frac{N}{8}\end{matrix}$$

Detect the first peak in Corr ((−M:M), say j, for which Corr(j)≥Corr (k) for any k>j and Corr(j)>Corr (m) for any m<j. Corr(j) is the peak cross correlation level Corr_peak.

In some implementations, motion detection operations based on CIR magnitudes may include a coarse motion detection operation and a fine motion detection operation. For the coarse motion detection operation, movement data is collected periodically and infrequently, such as every T1 seconds, and a first number N1 of frames are processed each time. If no motion is detected, the coarse motion detection operation continues. If motion is detected, then the fine motion detection operation may be used. For the fine motion detection operation, movement data is collected continuously, such as every T2 seconds, where T2<T1, and a second number N2 of frames are processed each time. In some aspects, the fine motion detection operation may be performed a number K times. If motion is detected more than a number Q out of K times, where Q<K, then a presence of motion may be indicated. Otherwise, the coarse motion detection operation may be used.

In some implementations, the coarse motion detection operation may include the following steps:
Step#1. Run N1 packets each time and determine N1 CIRs. Compute the magnitude of the CIR to determine N1 CIR magnitudes.
Step#2. Compute the peak cross correlation between packet j+1 and packet j, j=1, 2, . . . , N1−1, to determine N1−1 peak cross correlation levels.
Step#3. Determine the minimum of the N1−1 peak cross correlation levels.
Step#4. If the minimum is less than the correlation degree threshold CDₜₕ^{final}, then coarse motion is detected and the fine motion detection operations may be used. Otherwise, repeat steps #1 to #3.

In some implementations, the fine motion detection operation may include the following steps:
Step#1. Run N2 packets each time and determine N2 CIRs. Compute the magnitude of the CIRs to determine N2 CIR magnitudes.
Step#2. Compute the peak cross correlation between packet i+1 and packet i, i=1, 2, . . . , N2−1, to determine N2−1 peak cross correlation levels.
Step#3. Determine the minimum of the N2−1 peak cross correlation levels.
Step#4. Repeat steps #1 to #3 for K times and determine K min.
Step#5. If more than Q out of the K min values are less than the correlation degree threshold CDₜₕ^{final}, then a presence of motion may be indicated. Otherwise, the coarse motion detection operation may be used.

In some implementations, a presence of motion may be detected or indicated if, at any time, a packet or frame exhibits a correlation degree that is less than an exception value. The exception value may be a relatively low value (such as compared with the correlation threshold) selected to ensure that the packet or frame has a CIR magnitude profile that is very different than (or otherwise distinguishable) from the previous CIR magnitude profile caused by motion.

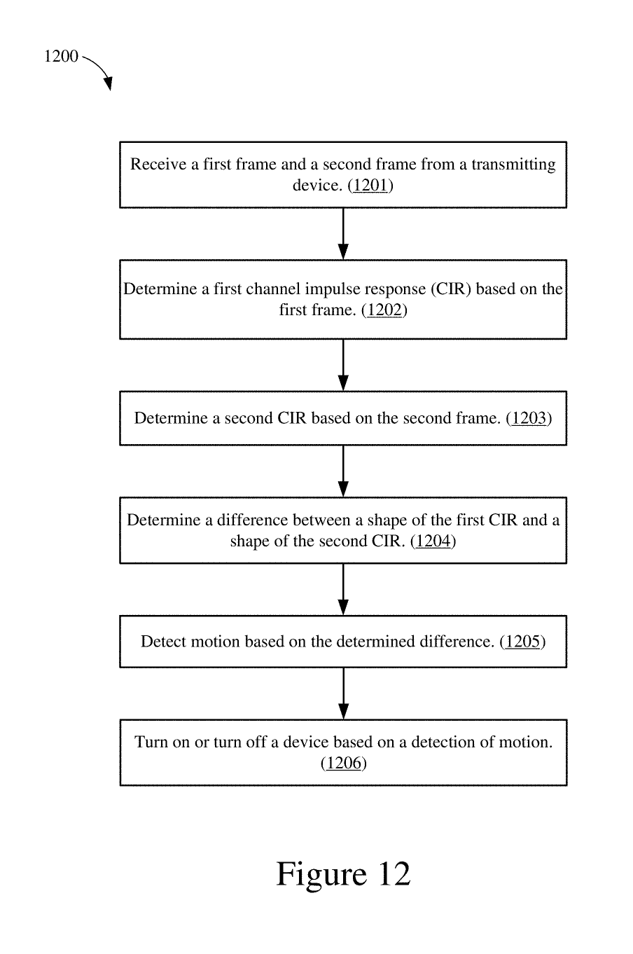

FIG. 12 shows an illustrative flow chart depicting an example operation 1200 for detecting motion. The example operation 1200 is described with respect to the device D1 and the room 410 of FIGS. 4A-4C for simplicity only. One of ordinary skill in the art can readily understand that the example operation 1200 disclosed herein may be performed by other suitable devices. For purposes of discussion herein, the motion detection operation 1200 is performed by device D1 based on one or more wireless signals received from a transmitting device. In some aspects, the transmitting device may be device D2 of FIGS. 4A-4C.

Device D1 may receive a first frame and a second frame from the transmitting device (1201). In some implementations, the first frame and the second frame may be received in the same wireless signal. In other aspects, the first frame may be received in a first wireless signal, and the second frame may be received in a second wireless signal distinct from the first wireless signal.

Device D1 may determine a first channel impulse response (CIR) based on the first frame (1202), and may determine a second CIR based on the second frame (1203). Device D1 may determine a difference between a shape of the first CIR and a shape of the second CIR (1204). In some implementations, the difference may indicate a degree of correlation between the first CIR and the second CIR. In other implementations, the difference may indicate a degree of correlation between amounts of multipath associated with the first and second frames.

Device D1 may detect motion based on the determined difference (1205). In some implementations, device D1 may indicate a presence of motion based on the difference exceeding a value, and may indicate an absence of motion based on the difference not exceeding the value.

In addition, or in the alternative, device D1 may turn on or turn off a device based on a detection of motion (1206). For one example, device D1 can turn itself on when motion is detected in its vicinity, and can turn itself off when motion is not detected in its vicinity (for at least a time period). For another example, device D1 can cause another device to turn itself on when motion is detected, and can cause the other device to turn itself off when motion is not detected in its vicinity (for at least a time period).

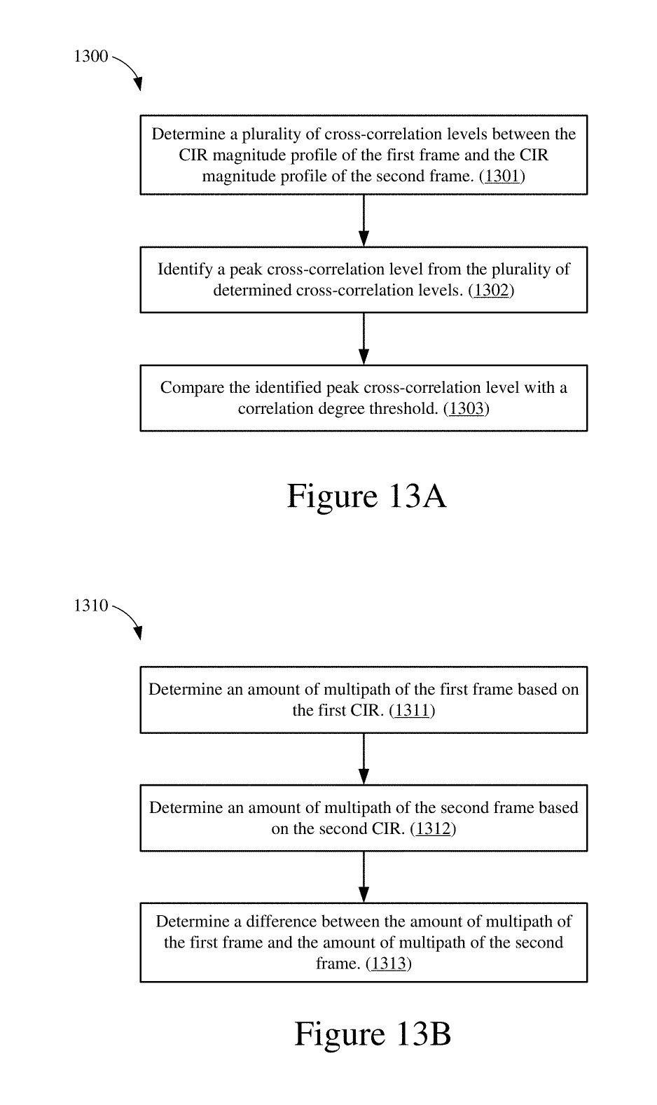

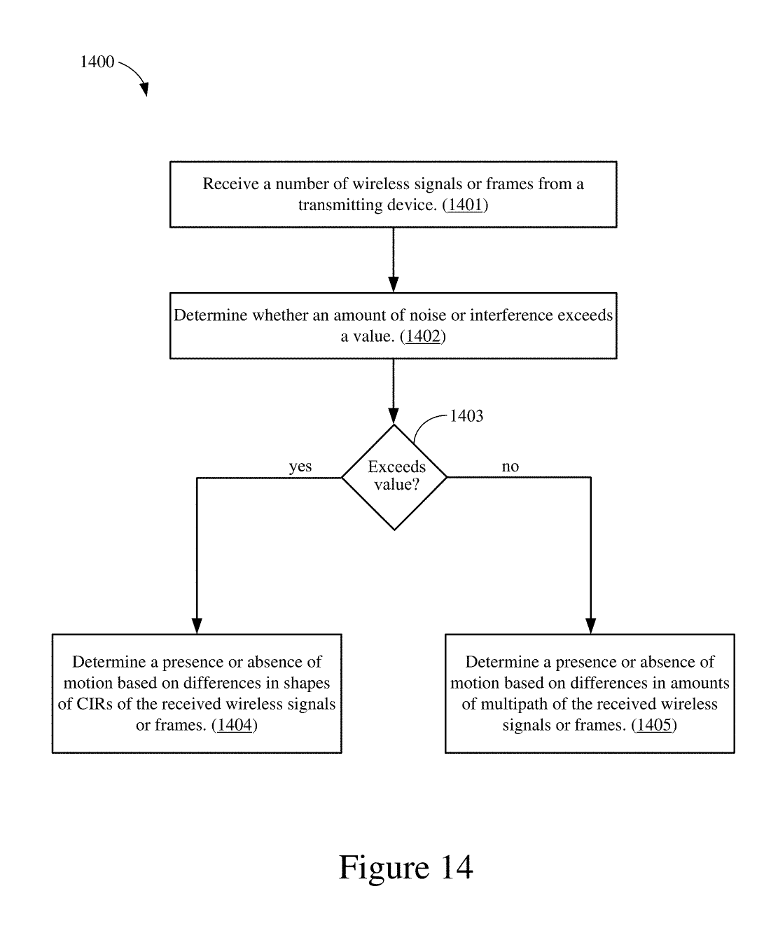

FIG. 13A shows an illustrative flow chart depicting an example operation 1300 for determining a difference between the first CIR and the second CIR. For the example operation 1300, the first CIR comprises a CIR magnitude profile of the first frame, and the second CIR comprises a CIR magnitude profile of the second frame.

Device D1 may determine a plurality of cross-correlation levels between the CIR magnitude profile of the first frame and the CIR magnitude profile of the second frame (1301), and may identify a peak cross-correlation level from the plurality of cross-correlation levels (1302).

Device D1 may compare the identified peak cross-correlation level with a correlation degree threshold (1303). In some aspects, the device D1 may indicate a presence of motion based on the identified peak cross-correlation level not exceeding the correlation degree threshold, and may indicate an absence of motion based on the identified peak cross-correlation level exceeding the correlation degree threshold.

FIG. 13B shows an illustrative flow chart depicting another example operation 1310 for determining a difference between the first CIR and the second CIR. For the example operation 1310, the first device D1 may reduce the computational complexity of detecting motion (as compared to the example operation 1300 of FIG. 13A) by using differences in amounts of multipath to detect motion, which may not involve determining either power CIR profiles or magnitude CIR profiles of received frames or received wireless signals.

Device D1 may determine an amount of multipath of the first frame based on the first CIR (1311), and may determine an amount of multipath of the second frame based on the second CIR (1312). In some implementations, device D1 may determine the multipath amounts based on channel impulse responses of the first and second frames, for example, as described with respect to FIGS. 5A-5C.

Device D1 may determine a difference between the amount of multipath of the first frame and the amount of multipath of the second frame (1313). In some aspects, the device D1 may indicate a presence of motion based on the difference exceeding a value, and may indicate an absence of motion based on the difference not exceeding the value.

FIG. 14 shows an illustrative flow chart depicting another example operation 1400 for detecting motion. The example operation 1400 is described with respect to the device D1 and the room 410 of FIGS. 4A-4C for simplicity only. One of ordinary skill in the art can readily understand that the example operation 1400 disclosed herein may be performed by other suitable devices. For purposes of discussion herein, the motion detection operation 1400 is performed by device D1 based on one or more wireless signals received from a transmitting device. In some aspects, the transmitting device may be device D2 of FIGS. 4A-4C.

Device D1 may receive a number of wireless signals or frames from the transmitting device (1401), and may determine whether an amount of noise or interference in the room 410 exceeds a value (1402). In some implementations, the value may correspond to levels of ambient noise and interference that are sufficiently high to render a detection of motion based on amounts of multipath in wireless signals difficult or inaccurate.

If the amount of noise or interference in the room 410 exceeds the value (which may indicate that the room 410 is a multipath rich environment), as tested at 1403, then device D1 may determine a presence or absence of motion in the room 410 based on differences in shapes of channel impulse responses (CIRs) of the received wireless signals or frames (1404). In some implementations, device D1 may use the motion detection operation 1200 of FIG. 12 to detect motion when the room 410 is designated as a multipath rich environment.

Conversely, if the amount of noise or interference in the room 410 does not exceed the value (which may indicate that the room 410 is not a multipath rich environment), as tested at 1403, then device D1 may determine a presence or absence of motion in the room 410 based on differences in amounts of multipath of the received wireless signals or frames (1405).

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those of ordinary skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of motion detection, comprising:
receiving a first frame and a second frame from a transmitting device;
determining a first channel impulse response (CIR) based on the first frame;
determining a second CIR based on the second frame;
determining a difference between a shape of the first CIR and a shape of the second CIR; and
detecting motion based on the determined difference.

2. The method of claim 1, wherein the detecting comprises:
indicating a presence of motion based on the difference exceeding a value; and
indicating an absence of motion based on the difference not exceeding the value.

3. The method of claim 1, wherein the first frame and the second frame are received in the same wireless signal.

4. The method of claim 1, wherein the first frame is received in a first wireless signal, and the second frame is received in a second wireless signal distinct from the first wireless signal.

5. The method of claim 1, wherein the difference comprises a degree of correlation between the first CIR and the second CIR.

6. The method of claim 1, wherein the first CIR comprises a CIR magnitude profile of the first frame, and the second CIR comprises a CIR magnitude profile of the second frame.

7. The method of claim 6, wherein determining the difference comprises:
determining a plurality of cross-correlation levels between the CIR magnitude profile of the first frame and the CIR magnitude profile of the second frame;
identifying a peak cross-correlation level from the plurality of determined cross-correlation levels; and
comparing the identified peak cross-correlation level with a correlation degree threshold.

8. The method of claim 7, wherein the detecting comprises:
indicating a presence of motion based on the identified peak cross-correlation level not exceeding the correlation degree threshold; and
indicating an absence of motion based on the identified peak cross-correlation level exceeding the correlation degree threshold.

9. The method of claim 1, wherein the first CIR comprises a CIR power profile of the first frame, and the second CIR comprises a CIR power profile of the second frame.

10. The method of claim 1, wherein determining the difference comprises:
determining an amount of multipath of the first frame based on the first CIR;
determining an amount of multipath of the second frame based on the second CIR; and
determining a difference between the amount of multipath of the first frame and the amount of multipath of the second frame.

11. The method of claim 10, wherein the detecting comprises:
indicating a presence of motion based on the difference exceeding a value; and
indicating an absence of motion based on the difference not exceeding the value.

12. The method of claim 1, further comprising:
turning on or turning off a device based on a detection of motion.

13. An apparatus, comprising:
one or more processors; and
a memory comprising instructions that, when executed by the one or more processors, cause the apparatus to:
receive a first frame and a second frame from a transmitting device;
determine a first channel impulse response (CIR) based on the first frame;
determine a second CIR based on the second frame;
determine a difference between a shape of the first CIR and a shape of the second CIR; and
detect motion based on the determined difference.

14. The apparatus of claim 13, wherein execution of the instructions to detect motion causes the apparatus to:
indicate a presence of motion based on the difference exceeding a value; and
indicate an absence of motion based on the difference not exceeding the value.

15. The apparatus of claim 13, wherein the first frame and the second frame are received in the same wireless signal.

16. The apparatus of claim 13, wherein the first frame is received in a first wireless signal, and the second frame is received in a second wireless signal distinct from the first wireless signal.

17. The apparatus of claim 13, wherein the difference comprises a degree of correlation between the first CIR and the second CIR.

18. The apparatus of claim 13, wherein the first CIR comprises a CIR magnitude profile of the first frame, and the second CIR comprises a CIR magnitude profile of the second frame.

19. The apparatus of claim 18, wherein execution of the instructions to determine the difference causes the apparatus to:
determine a plurality of cross-correlation levels between the CIR magnitude profile of the first frame and the CIR magnitude profile of the second frame;
identify a peak cross-correlation level from the plurality of determined cross-correlation levels; and
compare the identified peak cross-correlation level with a correlation degree threshold.

20. The apparatus of claim 19, wherein execution of the instructions to detect motion causes the apparatus to:
indicate a presence of motion based on the identified peak cross-correlation level not exceeding the correlation degree threshold; and
indicate an absence of motion based on the identified peak cross-correlation level exceeding the correlation degree threshold.

21. The apparatus of claim 13, wherein the first CIR comprises a CIR power profile of the first frame, and the second CIR comprises a CIR power profile of the second frame.

22. The apparatus of claim 13, wherein execution of the instructions to determine the difference causes the apparatus to:
determine an amount of multipath of the first frame based on the first CIR;
determine an amount of multipath of the second frame based on the second CIR; and
determine a difference between the amount of multipath of the first frame and the amount of multipath of the second frame.

23. The apparatus of claim 22, wherein execution of the instructions to detect motion causes the apparatus to:
indicate a presence of motion based on the difference exceeding a value; and
indicate an absence of motion based on the difference not exceeding the value.

24. A non-transitory computer-readable medium storing instructions that, when executed by one or more processors of a wireless device, cause the wireless device to perform operations comprising:
receiving a first frame and a second frame from a transmitting device;
determining a first channel impulse response (CIR) based on the first frame;
determining a second CIR based on the second frame;
determining a difference between a shape of the first CIR and a shape of the second CIR; and
detecting motion based on the determined difference.

25. The non-transitory computer-readable medium of claim 24, wherein the difference comprises a degree of correlation between the first CIR and the second CIR.

26. The non-transitory computer-readable medium of claim 24, wherein the first CIR comprises a CIR magnitude profile of the first frame, and the second CIR comprises a CIR magnitude profile of the second frame.

27. The non-transitory computer-readable medium of claim 26, wherein execution of the instructions for determining the difference causes the wireless device to perform operations further comprising:
determining a plurality of cross-correlation levels between the CIR magnitude profile of the first frame and the CIR magnitude profile of the second frame;
identifying a peak cross-correlation level from the plurality of determined cross-correlation levels; and
comparing the identified peak cross-correlation level with a correlation degree threshold.

28. The non-transitory computer-readable medium of claim 27, wherein execution of the instructions for detecting motion causes the wireless device to perform operations further comprising:
indicating a presence of motion based on the identified peak cross-correlation level not exceeding the correlation degree threshold; and
indicating an absence of motion based on the identified peak cross-correlation level exceeding the correlation degree threshold.

29. The non-transitory computer-readable medium of claim 24, wherein execution of the instructions for determining the difference causes the wireless device to perform operations further comprising:
determining an amount of multipath of the first frame based on the first CIR;
determining an amount of multipath of the second frame based on the second CIR; and
determining a difference between the amount of multipath of the first frame and the amount of multipath of the second frame.

30. A wireless device, comprising:
means for receiving a first frame and a second frame from a transmitting device;
means for determining a first channel impulse response (CIR) based on the first frame;
means for determining a second CIR based on the second frame;
means for determining a difference between a shape of the first CIR and a shape of the second CIR; and
means for detecting motion based on the determined difference.
